(19) United States
(12) Patent Application Publication
(10) Pub. No.: US 2011/0016025 A1
(43) Pub. Date: Jan. 20, 2011

(54) APPARATUS AND METHOD FOR MANAGING COLLECTIONS

(76) Inventor: R. Brandon Gaisford, Kihei, HI (US)

Correspondence Address: PATTON BOGGS LLP, 1801 CALFORNIA STREET, SUITE 4900, DENVER, CO, 80202, US

(21) Appl. No.: 12/839,233

(22) Filed: Jul. 19, 2010

Related U.S. Application Data
(60) Provisional application No. 61/226,564, filed on Jul. 17, 2009.

(51) Int. Cl. G06F 17/30; G06Q 30/00; G06F 15/16; G06F 3/048

(52) U.S. Cl. 705/27.1; 707/803; 715/843; 707/E17.044; 709/203; 715/810

(57) ABSTRACT

A client portable computer system for assisting a collector of collectible items, such as the following collectible types: coins, stamps, comic books, artworks, trading cards, motor vehicles, recordings and autographed documents. The client computer is networked with a server that includes a database that includes a listing of items in a personal collection of the collector and details of the items. The system also includes a drill down tool that can quickly move through a plurality of information levels to access detailed information regarding collectible items of the collectible type in the personal collection. The system provides a collectible exchange wherein individuals who want to buy a particular collectible item and individuals who want to sell the collectible item are notified of their proximity and can negotiate a price.

### CROSS-REFERENCE TO RELATED APPLICATIONS

This application claims the benefit of U.S. Provisional Application No. 61/226,564 filed Jul. 17, 2009.

### BACKGROUND OF THE INVENTION

1. Field of the Invention

The invention relates generally to the field of managing data and in particular managing data relating to collections, such as coin or stamp collections.

2. Statement of the Problem

Millions of individuals maintain collections, such as coin, stamp, comic book, book, gun, knife, gem, bottle, car, matchbook covers, photographs, art, camera, musical instruments, baseball and other cards, bugs, license plates, beer can etc. The list is endless. While collections often start as simply throwing coins or stamps in a box, if the collector is serious he or she begins to organize the collection, such as by placing the individual items in a book or album, and keeping a list of items, with the list including a variety of information about each item.

Most serious collectors keep records of their collection sometimes using spreadsheet programs or other types of databases, but often simply using word processing programs, which we have represented in FIG. 22. In system 2200, a user inputs a request to a software application, which we refer to as a registry application, installed in computer 2210 via input device 2220. The request/response function illustrated by arrow 2230. The response is typically the creation of a record. Such records usually include information about the value of the individual items and the collection as a whole. Serious collectors are also avid buyers and sellers of the type of items they collect. Such buying and selling required a significant amount of information regarding relative value of an item. Using coin collecting as an example, until the late 1980's buying and selling coins was difficult because of the lack of value information: no one could agree whether one coin was better than another. Today, coins are differentiated from one another using a 70 point scale, with a 70 being a perfect coin. Before third party grading services existed, dealers pretty much dictated the grade of the coins. This was not satisfactory since it was a little like the wolf guarding the hen house. So in the late 1980s new 3rd party grading service companies were formed to address this issue. For a small fee, a coin can be sent to the service, the coin will be objectively examined by an expert, and then returned with an official grade. This was a significant boost to coin collecting hobbyists as it now became possible to buy/sell/trade coins sight unseen. Similar services exist for stamps and other collection types.

The two largest coin grading services, Numismatic Guaranty Corporation (NGC) and Professional Coin Grading Service (PCGS) have coin registries, which can be found at http://coins.www.collectors-society.com/ and http://www.pcgs.com/setregistry, respectively. A third coin registry is the Tantalus Online Registry at http://www.tantaluscoins.com/register.php. These registries comprise online databases in which users can record their collection, make their collection data available to others, and browse collections of others. The simplest form for such registries is illustrated by system 2300 in FIG. 23. System 2300 includes a user's client computer 2308, and a registry server 2310 on which is installed registry web site application software. The user presents requests represented by arrow 2320 which pass through the internet 2315 and are transmitted to server computer 2310 as illustrated by arrow 2330. The web site application software responds in the other direction, typically with an indication that a record has been made or with other information, such as information about collections of others who use the registry. A third form of a collection system, such as shown in FIG. 24. The system 2400 of FIG. 24 includes a plurality of user computers 2405 and 2410 and a server 2430 in which is stored Broker Auction Web Site software. The Broker sets pricing, posts items for sale on their web site, and directs prospective buyers such as User C and D to sellers such as User A. User A has an item 2440 to sell, which the user communicates to computer 2430 via the Broker as illustrated at 2435. Users C and D communicate with server 2430 via client computers 2405 and 2410 and internet 2414 as illustrated at 2415, 2416 and 2420. Both user C and User D bid on item 2440 and User C provides the winning bid, which is communicated to User A. User A must then complete the purchase with User C. With such systems, the registries permit users to track their inventory, and brokers allow their users to buy and sell coins to build and complete sets of coins. Registries also allow users to compete with other hobbyists as awards are given yearly for outstanding collections. The registries also provide links to publications and news items of interest to coin collectors, links to coin auctions and exchanges, links to web pages for coin exhibits and shows, and include advertising or interest to coin collectors. Similar registries exist for other types of collectible items.

Another prior art system 2500 which is often used by collectors is shown in FIG. 25. This is the well-know Auction web site, as exemplified by eBay. System 2500 includes client computers 2510, 2520 and 2550 which communicate with server 2530 via internet 2514 and 2560 as indicated at 2516, 2518, 2536 and 2540. User A has an item for sale which he registers with the Auction Web Site. A minimum price and possibly other constraints on bidding are set by User A. In this case User B submits the winning bid and the completed sale information is sent to User A who sends the item to User B. Payment may be made through a third party Payment Gateway, such as Pay Pal.

While the online registries provide considerable information about coins, this information is not in a form it can be useful to individual collectors. In fact, it in some ways is a hindrance. The registries focus on the registry business and are geared toward increasing their share of that business. The user that wants to buy coins is directed to coins in which the particular registry has a vested business interest. Information regarding coin sets is geared toward selling coin sets owned by the particular registry. Registries do not allow users to buy and sell their own coins. By building networks of local coin dealers, the registries have also reduced the opportunity for the average collector to compete against the professional. These networks are driving out the independent coin dealers that at one time could be relied on for independent information. Despite the advance in information technology, individual coin collectors remain at a disadvantage to professionals with regard to information useful in finding and pricing coins. In other collector areas, the ability of an individual collector to obtain current information related to the collecting type is significantly worse. The generalized auction systems, such as eBay, provide even less information than the specialized registries and present many new issues such as difficulty in verifying and tracking collectible information. In the field of collecting, there remains a great need for tools and information that level the playing field for the average collector and make it easy and natural to collect, buy and sell collectibles.

### SUMMARY OF THE INVENTION

The invention solves the above problems, as well as other problems of the prior art, by providing to the average collector at least three elements that never before have been available: the collector's collection in an easily and quickly parsable form; the current prices of collectible items; and the ability to access the foregoing information at the placed and time it is needed.

The invention solves the above and other problems and puts the average collector on a par with those with greater resources by providing a portable computer system that puts all relevant information pertinent to buying, selling and collecting the particular collectible of interest at the collector's fingertips. The invention pertains particularly to collectible items such as coins, stamps, comic books, artworks, trading cards, motor vehicles, recordings or autographed documents, but may also be applied to other collectibles.

The invention provides a server database that is easily accessible via wired or wireless connection to the internet. The database includes the individual items of the personal collection of the collector, nicely accessible via a drill down tool through categories and classes. Here, a category of collectibles means a group of collectibles all of the same type, e.g., coins or stamps, which had one or more similarities at the time of issue or manufacture, but also have one or more significant differences, such as a different date. For example, all US quarter dollars is a category, and all US Kennedy silver-clad half dollars is a narrower, category. A class of collectible items means a group of collectible items that originally were manufactured essentially identically, such as all Kennedy silver-clad half dollars manufactured by the Denver mint in 1967. Similarly, detailed information is available about almost any collectible item that the individual collector may have an interest in. For example, if a collector happens to be browsing through an antique shop in the Upper Peninsula of Michigan, or perhaps at a coin show in Los Angeles, and runs across a coin he has never seen before, using the drill down system and information available on the face of the coin, the collector can access essentially all information on the server database as well as most information available at coin registries and internet sources throughout the world.

The invention provides a method for assisting a collector of collectible items, the method comprising: establishing a collection database on a server computer system, the collection database including: a first list of collectible items selected from the group consisting of coins, stamps, comic books, artworks, trading cards, motor vehicles, recordings and autographed documents, the first list associated with a collection identifier; and first detail information relating to the collectible items in the first list; providing a portable client computer system remote from the server computer system, the client computer system including an input device, a memory, a processor and a display; establishing a collection management tool on the client computer system, the collection management tool including the first list of collectible items and the collection identifier; establishing a communications link between the client computer system and the server computer system; entering update information regarding the first list of collectible items associated with the list identifier; updating either the first list of collectible items associated with the collection identifier or the detail information relating to the collectible items in the first list on the server computer based on the update information; displaying on the display a listing of categories of the collectibles; responsive to input from the input device, requesting a second list of collectible items in one of the categories, the second list of collectible items including at least one collectible item not on the first list; displaying the second list of collectible items; responsive to input from the input device, retrieving and displaying second detail information relating to a collectible item not on the first list. Preferably, the first detail information is selected from the group consisting of: the date of purchase of a selected collectible item on the first list, the place from which the selected collectible item was purchased, and the purchase price of the selected collectible item. Preferably, the second detail information is selected from the group consisting of: the date of manufacture or issue of a class of collectible items of one of the collectible types; a quality grade of one or more collectible items in the class; and rarity information regarding the number of collectible items having the quality grade in the class. Preferably, the second detail information further includes the identification of where collectible items in the class may be purchased. Preferably, the method further comprises displaying a picture of a selected item on the first list. Preferably, the method further comprises displaying a current monetary value of a selected item in the first list displaying a current monetary value of a selected collectible item not on the first list. Preferably, the method further comprises displaying the spot price of one or more precious metals. Preferably, the method further comprises connecting the client computer to a registry for a collectible item on the first or second list. Preferably, the method further comprises finding a dealer in one of the types of collectible items within a predetermined distance from the client computer. Preferably, the second detail information comprises a published article about a collectible item not on the first list.

The invention also provides a system for assisting a collector or collectible items, the system comprising: a server computer system; a database on the server for storing information regarding collectible items selected from the collectible types consisting of coins, stamps, comic books, artworks, trading cards, motor vehicles, recordings and autographed documents; a portable client computer system remote from the server computer system, the client computer system including an input device, a memory, a processor and a display; a communication network connecting the server computer and the portable client computer; a drill-down tool on the portable client computer for accessing the detailed information, the drill-down tool having a plurality of levels including: a collectible category level in which a plurality of categories of one of the collectible types are listed on the display, a collectible item level in which individual collectible items of the collectible type are listed on the display, and a collectible detail level in which detail information relating to a selected one of the individual collectible items are displayed on the display. Preferably, the detail information comprises a picture of one of the individual collectible items. Preferably, the detail information is selected from the group consisting of: the date of manufacture or issue of a class of collectible items of one of the collectible types; a quality grade of one or more collectible items in the class; and rarity information regarding the number of collectible items having the quality grade in the class. Preferably, the detail information comprises a published article relating to the selected individual collectible item. Preferably, the detail information comprises a list of dealers which sell collectible items in the same class as the selected individual collectible item. Preferably, the detail information comprises a population report relating to collectible items in the same class as the selected individual collectible items. Preferably, the detail information comprises the identification of a collection of which the individual collectible item is a part. Preferably, the detail information comprises a current monetary value of the individual collectible item.

In still another aspect, the invention provides a method for assisting a collector of collectible items, the method comprising: establishing a collection database on a server computer system, the collection database including: a first list of collectible items of a type selected from the group consisting of coins, stamps, comic books, books, artworks, trading cards, motor vehicles, recordings and autographed documents, the first list associated with a collection identifier; first detail information relating to the collectible items in the first list; a second list of collectible items of the same type as the type of items in the first list, the second list including items in a particular category of the type of collectible and having at least one collectible item not on the first list; and second detail information relating to the collectible items in the second list; providing a client computer system remote from the server computer system, the client computer system including an input device, a memory, a processor and a display; establishing a collection management tool on the client computer system, the collection management tool including the first list of collectible items and the collection identifier; establishing a communications link between the client computer system and the server computer system; entering on the client computer update information regarding the first list of collectible items associated with the list identifier; updating either the first list of collectible items associated with the collection identifier or the detail information relating to the collectible items in the first list on the server computer based on the update information; displaying on the display of the client computer a listing of categories of the collectibles; responsive to input from the input device, requesting a list of collectible items in a the category corresponding to the category of the second list; displaying the second list of collectible items on the display; and responsive to input from the input device, retrieving and displaying second detail information relating to a collectible item in the second list not on the first list. Preferably, the first detail information comprises two pieces of detail information selected from the group consisting of: the date of purchase of a selected collectible item on the first list, the place from which the selected collectible item was purchased, and the purchase price of the selected collectible item; and the second detail information comprises two pieces of detail information selected from the group consisting of: the date of manufacture or issue of a class of collectible items of one of the collectible types; a quality grade of one or more collectible items in the class; rarity information regarding the number of collectible items having the quality grade in the class; and the identification of where collectible items in the class may be purchased; and a published article about a collectible item. Preferably, the further comprises: displaying on the first client computer display a picture of a selected item on the first list and displaying on the first client computer a current monetary value of a selected item in the first list. Preferably, the collectible item comprises coins and further comprising displaying on the client computer display the spot price of one or more precious metals. Preferably, the method further comprises connecting the client computer to a registry for a collectible item on the first or second list. Preferably, the method further comprises finding a dealer in one of the types of collectible items within a predetermined distance from the client computer. Preferably, the method further comprises selecting one of the displayed categories of collectibles, and creating a third list of collectibles in the category by automatically populating the third list with items in the selected category that exist.

In a further aspect, the invention also provides a system for assisting a collector or collectible items, the system comprising: a server computer system; a collection database on the server computer system for storing information regarding collectible items selected from the collectible types consisting of coins, stamps, comic books, books, artworks, trading cards, motor vehicles, recordings and autographed documents; the collection database including: a first list of collectible items of a first type, and first detail information relating to the collectible items in the first list; a first client computer system remote from the server computer system, the client computer system including a first input device, a first memory, a first processor and a first display; a communication network connecting the server computer and the client computer; and a drill-down tool on the client computer for accessing the detail information, the drill-down tool having a plurality of levels including: a collectible category level in which a plurality of categories of the first collectible type are listed on the display, a collectible item level in which individual collectible items of the collectible type are listed on the display, and a collectible detail level in which detail information relating to a selected one of the individual collectible items are displayed on the display. Preferably, the detail information comprises two pieces of information selected from the group consisting of: a picture of one of the individual collectible items; the date of manufacture or issue of a class of collectible items of one of the collectible types; a quality grade of one or more collectible items in the class; a current monetary value of the individual collectible item; rarity information regarding the number of collectible items having the quality grade in the class; a published article relating to the selected individual collectible item; a list of dealers which sell collectible items in the same class as the selected individual collectible item; and a population report relating to collectible items in the same class as the selected individual collectible items. Preferably, the detail information comprises the identification of a collection of which the individual collectible item is a part. Preferably, the collection database on the server computer system further includes a second list of the collectible items of the first type, and second detail information relating to the collectible items in the second list, the system further comprising: a second client computer system remote from the server computer system and the first client computer system, the second client computer system including a second input device, a second memory, a second processor and a second display, the second computer system connected with the network; and a drill-down tool on the second client computer system for accessing the second detail information, the drill-down tool having a plurality of levels including: a collectible category level in which a plurality of categories of one of the collectible types are listed on the display, a collectible item level in which individual collectible items of the collectible type are listed on the display, and a collectible detail level in which second detail information relating to a selected one of the individual collectible items in the second list are displayed on the second display. Preferably, the collectible item comprises coins.

In another aspect, the invention provides a method of buying, selling or exchanging collectibles, the method comprising: establishing a collection database on a server computer system, the collection database including: a first list of collectible items of a first type selected from the group consisting of coins, stamps, comic books, books, artworks, trading cards, motor vehicles, recordings and autographed documents, the first list associated with a first collection identifier; first detail information relating to the collectible items in the first list; a second list of collectible items of the first type, the second list associated with a second collection identifier; and second detail information relating to the collectible items in the second list; providing a first client computer system and a second client computer system, each of the first and second client computer systems being remote from the server computer system and each the client computer system including an input device, a memory, a processor and a display; establishing a collection management tool on the first client computer system, the collection management tool including the first list of collectible items and the first collection identifier; establishing a collection management tool on the second client computer system, the collection management tool including the second list of collectible items and the second collection identifier; establishing a communications link between the client computer systems and the server computer system; indicating on the first client computer system that a first item on the first list is for sale and communicating the first item and the indication to the second client computer; using the collection management tool on the second client computer, retrieving the detail information relating to the first item; and using the collection management tools on the first client computer and second client computer, selling the first item to a user of the second computer. Preferably, the communicating the first item to the second computer comprises: providing on the second computer a list of items in a first category, wherein the first category is a category that includes the first item; and providing on the list near the first item a visual indication that the first item is available for sale. Preferably, the visual indication comprises the number of the first items in the collection database that are for sale. Preferably, at least one of the first and second computers is a portable computer and further comprising providing a notification on the first computer, the second computer or both that the first computer is near the second computer. Preferably, the method further comprises automatically determining a price for the first item using price information in the collection database, the price information selected from the group consisting of: prices for existing items for sale within the database system; historical completed item sales within the database system; historical or current auction site sales; current dealer listings; third party pricing guides; and spot pricing at a trade show. Preferably, the collectible item type comprises coins.

In yet another aspect, the invention provides a method of buying, selling or exchanging coins, the method comprising: establishing a collection database on a server computer system, the collection database including: a first list of coins, the first list associated with a first collection identifier; first detail information relating to the coins in the first list; a second list of coins, the second list associated with a second collection identifier; and second detail information relating to the coins in the second list; providing a first portable client computer system and a second portable client computer system, each of the first and second portable client computer systems being remote from the server computer system and each the client computer system including an input device, a memory, a processor and a display; establishing a collection management tool on the first client computer system, the collection management tool including the first list of coins and the first collection identifier; establishing a collection management tool on the second client computer system, the collection management tool including the second list of coins and the second collection identifier; establishing a communications link between the portable client computer systems and the server computer system; providing on the first portable client computer an indication that a particular coin in a particular category of coins on the first list is for sale; providing on the second portable client computer system that a user of the second portable computer desires to buy a coin in the category of the particular coin; and providing on either the first portable computer that or the second portable computer that the first and second portable computers are in proximity to each other. Preferably, the method further providing to the first portable computer, the second portable computer, or both pricing information selected from the group consisting of prices for existing coins for sale within the database system; historical completed coins sales within the database system; historical or current auction site coin sales; current coin dealer listings; third party coin pricing guides; and spot pricing at a coin trade show.

The invention provides a collection management system that permits any collector, including professionals and amateurs to have all information necessary of good collection decisions at their fingertips at any time and place. Further, it permits the collector, rather than registry companies and coin grading services determine the information that is available. Numerous other features, objects, and advantages of the invention will become apparent from the following description when read in conjunction with the accompanying drawings.

### BRIEF DESCRIPTION OF THE DRAWINGS

FIG. 1 illustrates the hardware portion of an exemplary system according to the invention;

FIG. 2 shows a preferred embodiment of the drill down database design of the system according to the invention showing the preferred flow through the database;

FIG. 3 illustrates a generalized zeroth level or home screen providing access to various data or operations related to a user's collectibles;

FIG. 4 illustrates an exemplary collection screen on which a user's collectibles may be shown;

FIG. 5 illustrates an exemplary set screen on which sets of related collectibles may be shown;

FIG. 6 is a flow chart of the preferred embodiment of the archiving, i.e., synchronization, of data from the client computer;

FIG. 7 is a flow chart illustrating a preferred embodiment of the storage of data in the client computer local file;

FIG. 8 is a flow chart illustrating a preferred embodiment of a reconciliation of data by the server database system;

FIG. 9 shows one embodiment of the home or startup screen of a system according to the invention for use by a coin collector;

FIG. 10 shows an example of the first level screen of FIG. 4 as may be displayed for a coin collection system;

FIG. 11 shows an example of the a second level collection screen of FIG. 5 when the Scott's Killer Nickels item of FIG. 10 has been selected;

FIG. 12 illustrates typical item entries in the first level screen of FIG. 10 and the second level screen of FIG. 11;

FIG. 13 shows an example of a detail level coin collection screen as may be displayed if the 2000-P item of FIG. 11 has been selected;

FIG. 14 illustrates an exemplary embodiment of a screen useful for entering the grade item of the screen of FIG. 13;

FIG. 15 illustrates an exemplary embodiment of a screen for entering alphanumeric information such as price paid, sales price and certification number of the screen of FIG. 13;

FIG. 16 illustrates an exemplary embodiment of a screen useful for entering the dates, such as the date acquired in the screen of FIG. 13;

FIG. 17 illustrates an exemplary embodiment of a screen useful for selecting the certification authority in the screen of FIG. 13;

FIG. 18 illustrates an exemplary embodiment of an editing screen which is entered by clicking on the “Edit” button of a second level or Set Listing screen, such as the screen of FIG. 11;

FIG. 19 illustrates and exemplary embodiment of a new set selection screen that is reached by clicking on the “plus” button of a first level screen such as that of FIG. 10;

FIG. 20 illustrates a population screen that can be reached via the “Coin Info” drill down item in FIG. 9;

FIG. 21 illustrates the hardware portion of an exemplary system according to the invention such as that of FIG. 1, but from a perspective that illustrates the “coin exchange” feature of the invention;

FIG. 22 illustrates a prior art collection management system utilizing a client computer with a registry application installed;

FIG. 23 illustrates a prior art collection management system in which the registry application resides on a server computer;

FIG. 24 illustrates a prior art collection management system in which a Brokered Auction web site resides on a server computer;

FIG. 25 illustrates a prior art collection management system in which an auction application resides on an auction server;

FIG. 26 is a flow chart illustrating a preferred embodiment of a process according to the invention for ingesting an item value received from remote system;

FIG. 27 is a flow chart illustrating a preferred embodiment of a process according to the invention for purchasing a collectible;

FIG. 28 is a flow chart illustrating a preferred embodiment of a process according to the invention for pricing and selling a collectible;

FIG. 29 is a flow chart illustrating a preferred embodiment of a process according to the invention for purchasing an item in the proximity of the buyer; and

FIG. 30 illustrates an application screen of a cell phone with several exemplary collection management applications available.

### DETAILED DESCRIPTION OF THE PREFERRED EMBODIMENT

The present invention relates to a method and system for assisting a collector of collectible items in maintaining and enhancing a personal collection. The collectible items are preferably coins, stamps, comic books, books, artworks, trading cards, motor vehicles, recordings or autographed documents, but may be other collectibles. In this disclosure, a class of collectible items means a group of collectible items that originally were manufactured essentially identically, such as all Kennedy silver-clad half dollars manufactured by the Denver Mint in 1967. A category of collectibles means a group of collectibles all of the same type, e.g. coins or stamps, which had one or more similarities at the time of issue or manufacture, but also have one or more significant differences, such as a different date. For example, all US quarter dollars is a category, and all US Kennedy silver-clad half dollars is a narrower category.

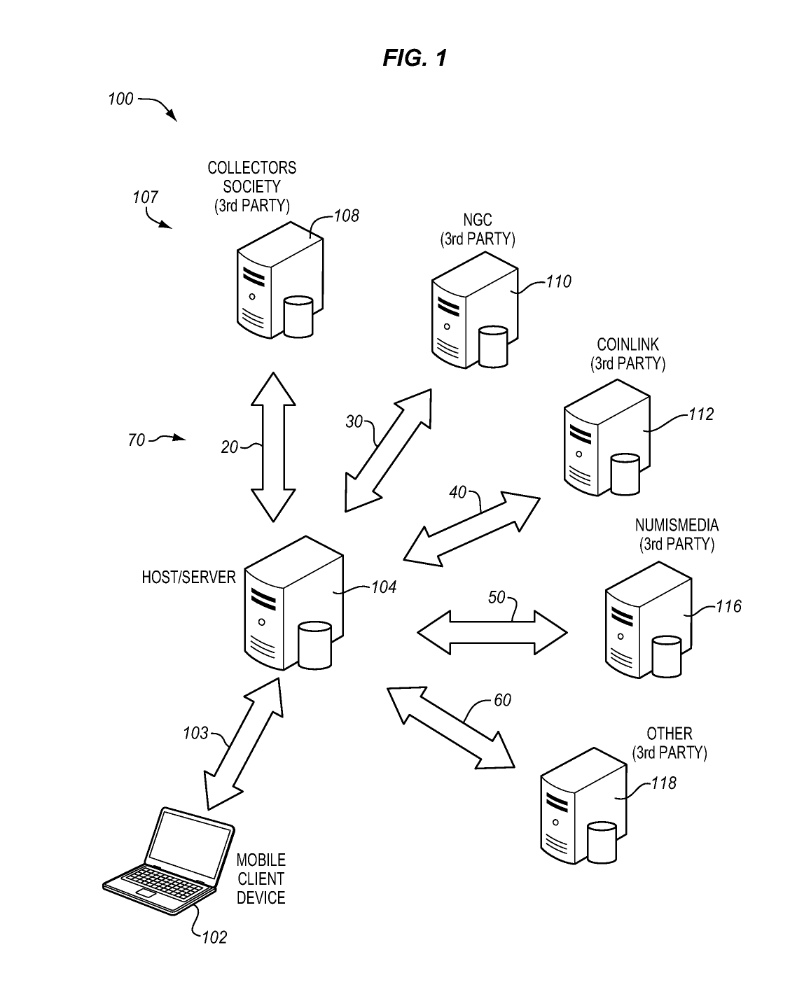

FIG. 1 is an architecture interconnection diagram illustrating the hardware portion of an exemplary system 100 according to the invention. The connection 103 between the client 102 and the application host computer 104 is preferably a standard HTTPS connection. Spot prices, ads and data synchronization between the client and the application host take place over this connection 103. General information about population, background, imagery etc. also is obtained using this connection. One skilled in the HTTPS art will understand that a client request may result in an HTTP/HTTPS redirect response. As a result, the client in some instances will communicate directly with a 3rd party system. In this disclosure, we shall discuss the system in terms of an embodiment related to coin collection, though, those skilled in the art, will understand that the system can be used for collecting other items also.

If the user is a member of the Collectors Society, the user may choose to have data synchronized between the application host 104 and the Collectors Society servers 108. This interconnection 20 may be a straight database connection. The connection may also be a web service call or a screen scraping activity over HTTPS. See http://www.collectors-society.com.

If the user has an NGC account, which account comes with a Collectors Society account, the user may retrieve from the NGC server 110 real time NGC population data for items within their collection. This interconnection 30 may be a straight JDBC database connection. The connection 30 may also be a web service call or a screen scraping activity over HTPS. See http://www.ngccoin.com.

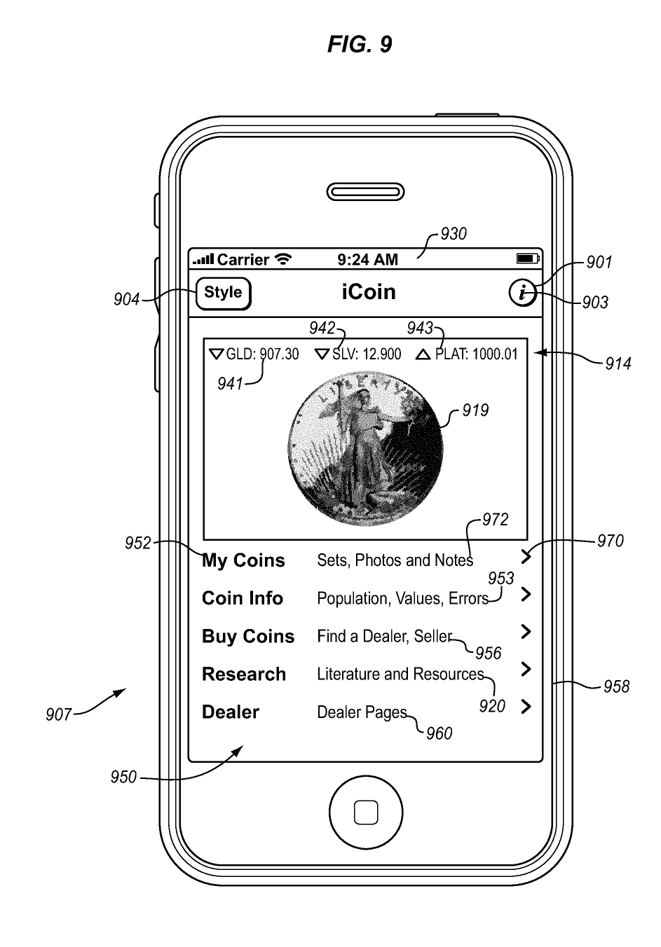

Connection 40 illustrates a connection to CoinLink, a third party server. General coin information for the detail view 910 (FIG. 9) preferably this connection but also may come from one of the above connection(s). Other third party information may be used such as historical information and imagery. Connection 40 may be either HTTP or HTTPS. Web services may also be used as well as direct JDBC database connections. See http://www.coinlink.com.

A multimedia server is illustrated at 16 and a connection to this server is shown at 50. Coin value information for the detail view may come from this connection. Third party information from this source may be used in the system according to the invention. This connection 50 may be either HTTP or HTTPS. Web services may also be used as well as direct JDBC database connection. See http://www.coinlink.com.

Other third party systems 118 may be queried for information via connection 60. These connections may be straight HTTP, HTTPS, Web Services, JDBC or other connections known in the art.

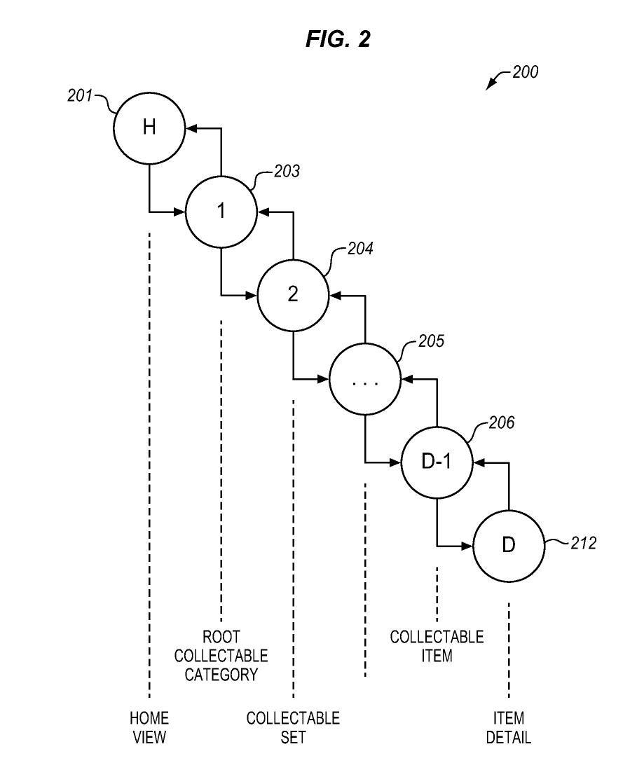

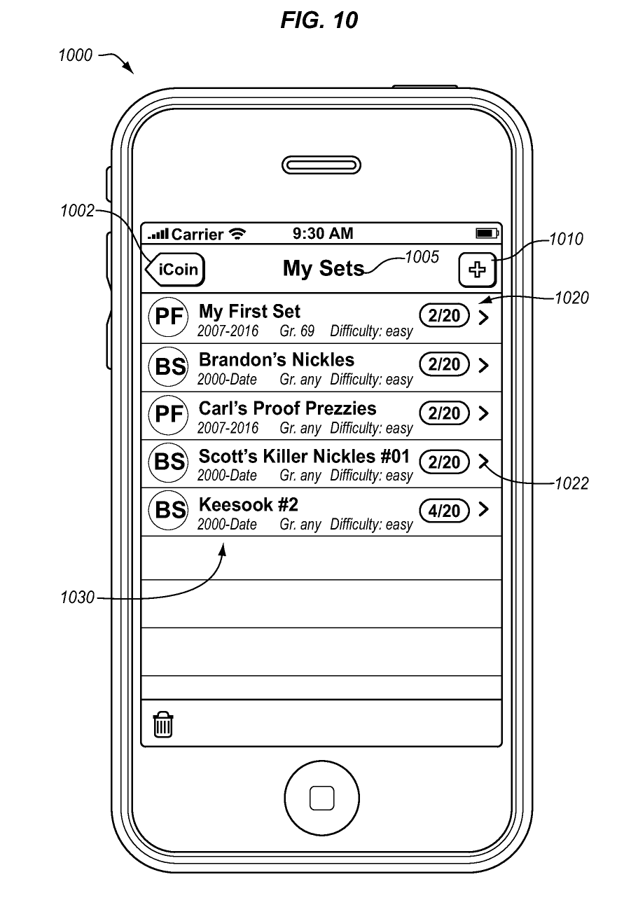

FIG. 2 shows a preferred embodiment of the drill down database design of the system according to the invention showing the preferred flow through the database. This figure represents a software flow that is used in many places in the system according to the invention, particularly on the client side database design. As shown, the flow from a home page view 201 through four or more levels 203, 204, 205, and 206 to an item bottom detail view 212. There may be several levels of detail such as 206 through 212. Level 203 preferably divides the collection into a plurality of root level categories for the particular collectible. An exemplary system with five root level categories is shown in FIG. 10 and will be discussed in detail below. However, other categories will be preferred by other collectors. In fact, the system according to the invention permits each collector to design his or her own root level categories.

Throughout the software application according to the invention, the user will drill down from the home menu 201 to a detail view as 212 as shown in FIG. 2. Normal flow would be navigation from view 201 to view 212. This drill down approach allows the user to quickly sift through large amounts of data and arrive at a representation of the information they are looking for. At each node 201-212 within the tree 200, the user may navigate back to the home level 201 without traversing all nodes in between.

Throughout the software application according to the invention, the sequence {1, 2, . . . , D−1} appears. This drill down pattern is continually repeated within the application. Although the depth of the tree may change, the fact that this pattern exists across collectable disciplines represents an application level pivot point. One set of the application code and/or database design may be written and used across a large number of collectable areas. This fact allows for many assumptions and simplifications in the database design. Within a specific software application, targeted at a specific collectable area (e.g. coins), it is possible to re-use the same constructs to search for a dealer of a specific item, to find the population information for a specific item, to view the high resolution imagery associated with a specific item as well as other uses.

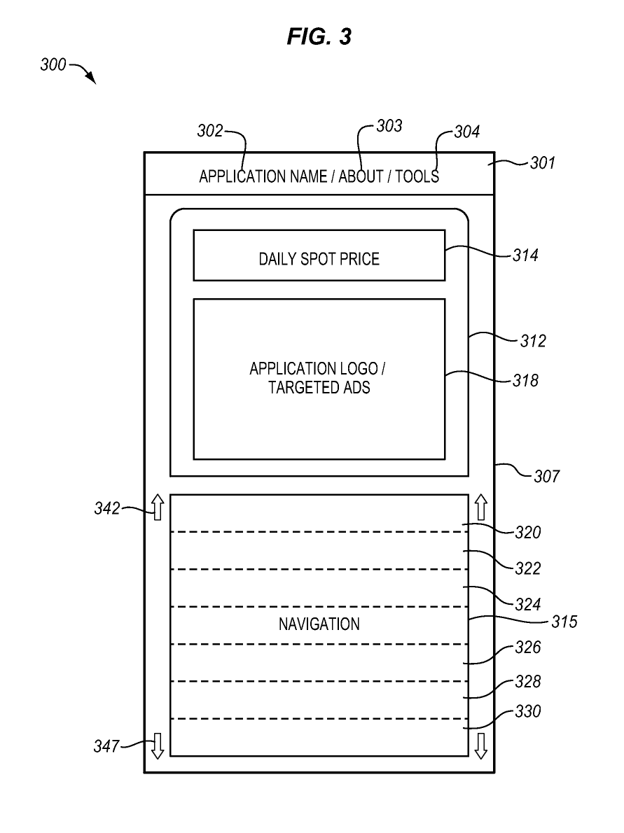

FIG. 3 illustrates a generalized “home” or startup screen 300 of the system according to the invention. This screen can be considered the zeroth level of the drill down database, corresponding to level 201 of FIG. 2. The header area 301 preferably contains the title 302 of the software application and other header information, such as an “about” button 303 which goes to a screen that gives information about the application. Header area 301 may also contain additional style tools 304, application credits, or other information. The main content is displayed in area 307, which will preferably include content specific to the particular application. Preferably, main content area 307 includes upper content display area display 312 and navigation area 315. It may also be divided into other areas. Preferably, in the coin collector application, the upper content display area 312 includes a daily price area 314 and an application area 318. The precious metal spot prices for the day, or other period may be displayed in area 314. The initial application logo may display in area 318 upon application launch. Later, as the application is used, targeted ads may also be displayed in this area. The navigation area 315 contains drill down item entrances 320, 322, 324, 326, 328, 330. Clicking on an entrance, or entry for short, permits the user to access data and perform operations of a specific category. FIG. 9 illustrates one embodiment of a home or start-up screen 900 and will be discussed below. The entries shown in FIG. 9 are “My Coins”, “Coin Info”, “Buy Coins”, “Research”, and “Dealer”. The user may use the “My Coins” entry to drill down into various sets of coins owned or otherwise of interest to the user. The user may use the “Coin Info” to drill down to information on essentially any coin that exists. It may include second level items such as “Countries”, which is a short-cut to coins of a particular country; “Watch List”, which is an entry to particular coins that the user wants to watch for availability, pricing, or other reasons; “Alerts”, which is an entry to particularly good pricing opportunities for coins; “Collections”, which provides a short-cut to particular collections; “Contacts”, which provides entry to communications with a list of friends or collectors which the user has relationships with, etc. Returning to FIG. 3, scroll arrows, such as 342 and 344, allow the user to scroll to other items than those shown. Similarly, for any other collectibles appropriate items are available. In touch screen devices one may access other items simply by rubbing a finger across the screen or by other conventional methods.

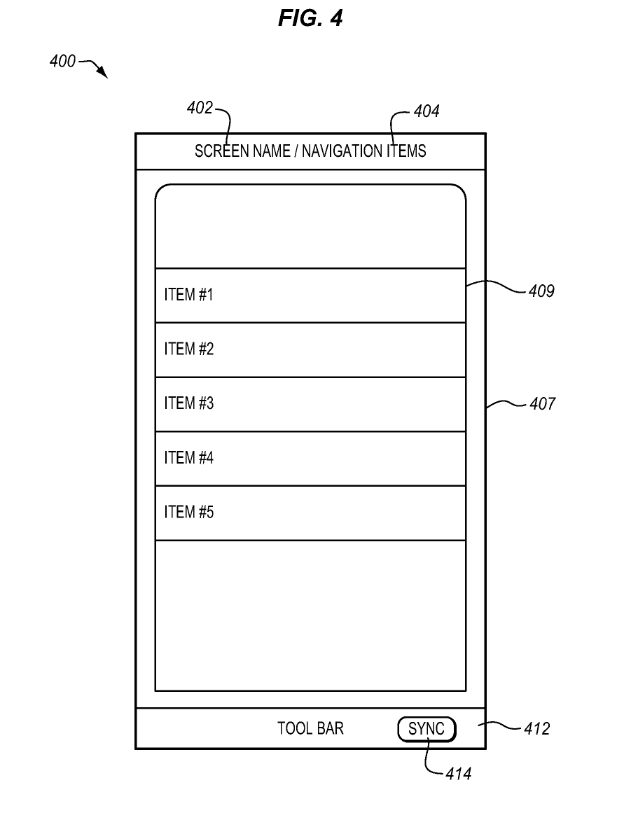

FIG. 4 illustrates an exemplary collection screen on which a user's collectibles may be shown, with each item preferably being a category representing a set of items. This screen corresponds to the first drill down level 203 of FIG. 2. In terms of navigation levels, the level of FIG. 4 is referred to as the root collectable category level. Preferably, the screen name 402 is shown at the top of the screen. An example screen name at this level might be “My Coins”, “My Sets”, or “My Comics”. These headings are generally descriptive of the page, so the user can quickly identify what he or she is looking at. The navigation item 404, which may be a button, an icon, a name or other indicator allows the user to navigate to the previous screen. Application content is shown in the main content display area 407. On this screen 400, the application content comprises selectable drill down item, such as 409. When an item such as 409 is selected the next level of information about that item is displayed. Tools that allow the user to modify or update the current view may be placed at 412 but may also be placed elsewhere as shown in FIGS. 10, 1 and 13. As an example, a sync button 414 allows the user to synchronize against the server 404 (FIG. 1) to see if new root level collectable items exist.

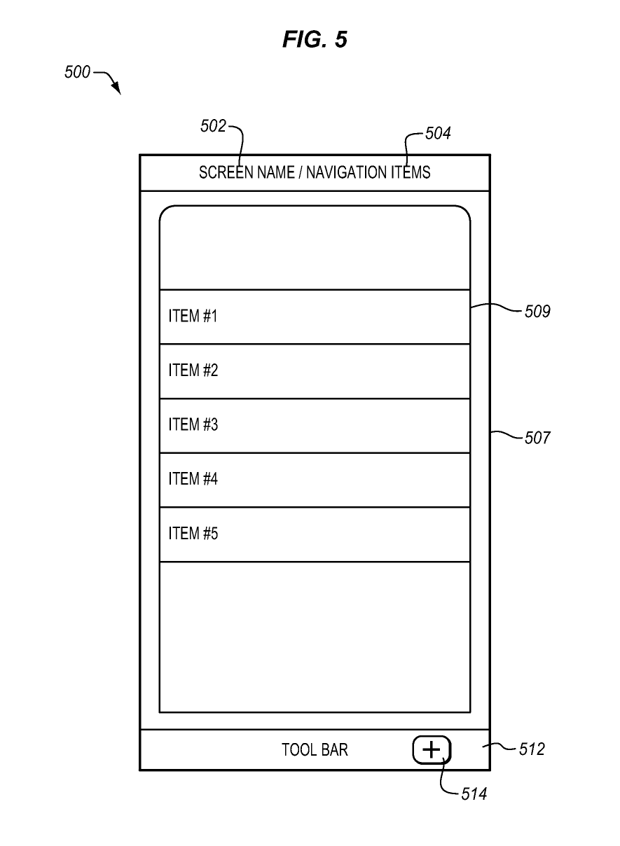

FIG. 5 illustrates an exemplary set screen 500 on which sets of related collectibles may be shown. In terms of navigation level, this screen corresponds to the second level 204 of FIG. 2 and may be referred to as the collectable set screen 500. The collectible set screen name is given at 502. An example screen name at this level might be “Eagles” if the application is a coin collection application or “Superman” if the application is a comic book collection application. Navigation items 504 on the screen allow the user to navigate to the previous screen or the home screen. Application content is shown in the main content display area 507. On this screen 500, the application content comprises selectable drill down item, such as 509. When an item such as 509 is selected the next level of information about that item is displayed. Tools that allow the user modify or update the current view may be placed at 512 of elsewhere. As an example, an add button (+) 514 allows the user to add a new item, e.g., a collectable set, to this view. As an example, a user may start a new collection of silver American eagle coins, or perhaps a new collection of Superman comics.

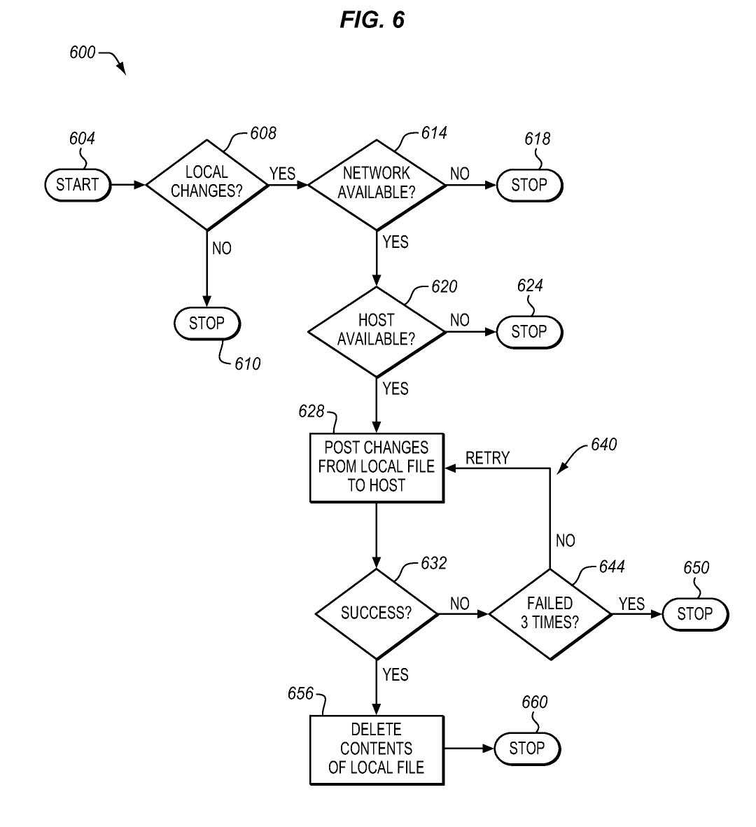

FIG. 6 is a flow chart illustrating a preferred embodiment of the process flow for archiving of data from the client computer. Preferably, this process occurs during client side application launch or from a manually initiated synchronization process. The process starts at 604. At 608 the process looks for any changes in the data in the client computer 102 (FIG. 1). If there are no changes, then the process terminates at 610. If there are changes, the process goes to 614, where it checks if the network 103 connecting it to the host server 104 is available. If not, the process terminates at 618. If the network 103 is available, the system checks at 620 to see if the host server 104 is available. If the host server is not available, the process terminates at 624. If the host server is available, the process 628 writes the changes in the local file to the host server 104. The system then checks at 632 to see if the write process was successful. If it was not successful, the system advances a counter at 644 and again attempts to post the changes to the host at 628. The system will circulate in loop 640 three times, each time advancing the counter at 644. If the system fails in the write process three times, the process terminates at 650. If the write is successful on any of the tries, the process preferably proceeds to 656 where the contents of the local file are deleted, then terminates at 660. However, if the local memory is large enough, the contents of the local file may not be deleted.

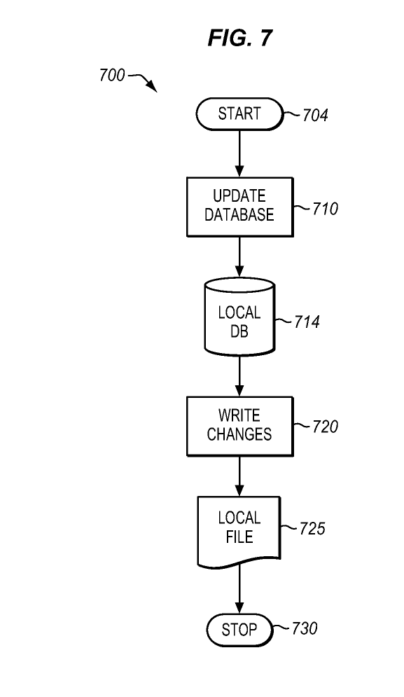

FIG. 7 is a flow chart illustrating a preferred embodiment of the process 700 for storage of data and the management of changes in the client computer local file. The change or update process starts at 704. At 710, a request is made for an update to the database, preferably triggered by the availability of new data. At 714, the local database is accessed. At 720, the new data is written to the database. Preferably, each change/update written to client local file will contain time stamp information. The time stamp will be generated using the current local client time and time zone offset as per the device at the time the change is created. Time stamps are preferably written in Greenwich Mean Time (GMT). The local file preferably stores changes in order of creation. At 725, the local file access is disengaged, and the process is terminated at 730.

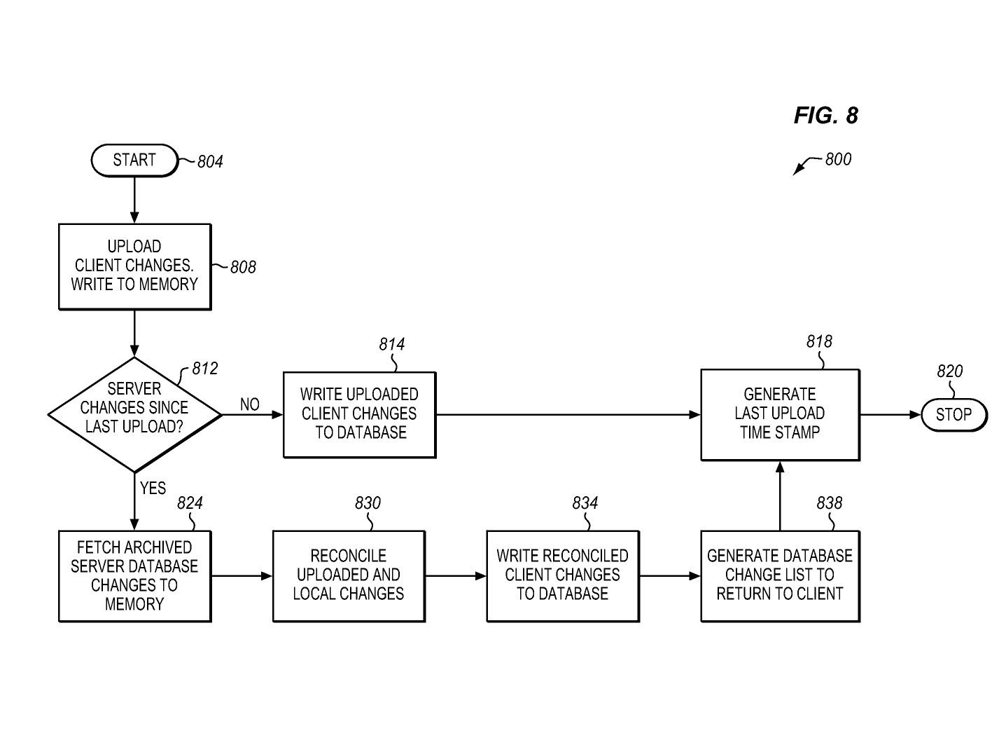

FIG. 8 is a flow chart illustrating a preferred embodiment of the process 800 for reconciliation of data by the server database system. This flow 800 outlines the upload of archived local database changes. The process 800 occurs during client side application launch or from a manually initiated synchronization process. Changes may exist on the server that the client has not yet seen. During this process 800 server side and client side changes are stitched together based on time stamps. The server database is updated based on the reconciliation, and new pending changes for the client are prepared for subsequent retrieval. The process 800 starts at 804. The client changes are uploaded to the server 104 at 808 and written to the server memory. At 812, the server checks for any changes in the server data since the last client upload. If there have been no changes to the server data, the client changes are uploaded to the server database at 814 with a time stamp generated at 818. If there have been server changes since the last upload the changes are fetched and written to the local memory. The uploaded and local changes are reconciled at 830, the reconciled changes are written to the server memory at 834. At 838, a database change list is generated and returned to the client computer where it is stored. A time stamp is then generated at 818 and the process terminates at 820.

FIG. 9 shows a specific embodiment 900 of the home or startup screen 300 of a system according to the invention for use by a coin collector. In this embodiment, the mobile client device, i.e., 102 in FIG. 1, is an iPhone™ 958. The conventional iPhone™ icons showing signal strength, connection to a carrier, the time, and battery condition are shown in area 930. Application header area 901 includes the application name formatting tools 904, and about button 903. The application area 914 includes the daily spot prices for gold 941, silver 942 and platinum 943 and a logo 919 that quickly and easily tells the user that the application for coin collection is running.

The main content display area 907 includes a list 950 of five entries to drill-down items, each allowing the user to explore a different field of information: a “My Coins” item 950, a population item 953, a “Buy Coins” item 956, a research item 920, and a dealer item 960. Each of these items corresponds to a top level item 203 of FIG. 2. Each item includes a title, such as “My Coins” 952, a detail description, such as “Sets, Photos and Notes” 972, disclosing what is in the drill down item, and a toggle, such as 970, which takes you to the next level of the drill down item. Each drill down item, such as 952, allows the user to enter multiple information levels, each one providing more detailed information in the item information field than the previous one. In this embodiment, the MY Coins has at least four levels including the top level 950 shown in FIG. 9 and three lower levels which will are shown in FIGS. 10-13 and will be discussed below. In general, information field 950 allows the user to find sets of coins, photos of sets or individual coins and notes made by the user regarding these coins. Information item 953 provides information about coins, such as population reports. The Buy Coins information field 956 allows the user to find either a nearby coin dealer or to drill down geographically or by type of dealer to find an appropriate dealer. The Research item 956 permits the user to find literature and other resources of information regarding coins. Dealer field 960 allows dealers to view pertinent pages specific to coin dealers such as sales information cross cuts, dealers' dashboards, etc. The “Coin Info” and “Research” fields include a text based search capability (not shown) that may be used in place of the drill down approach.

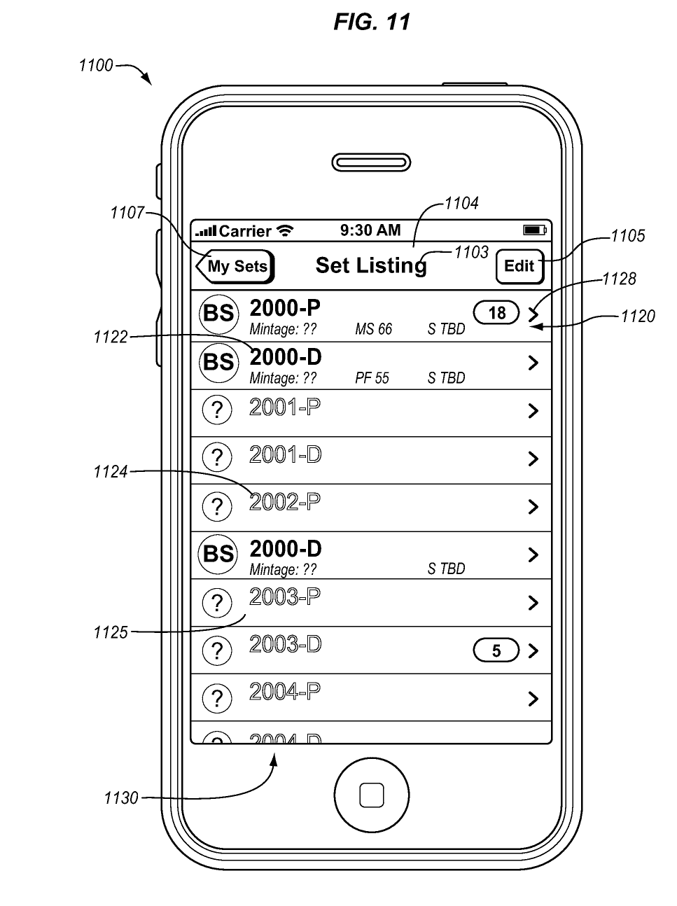

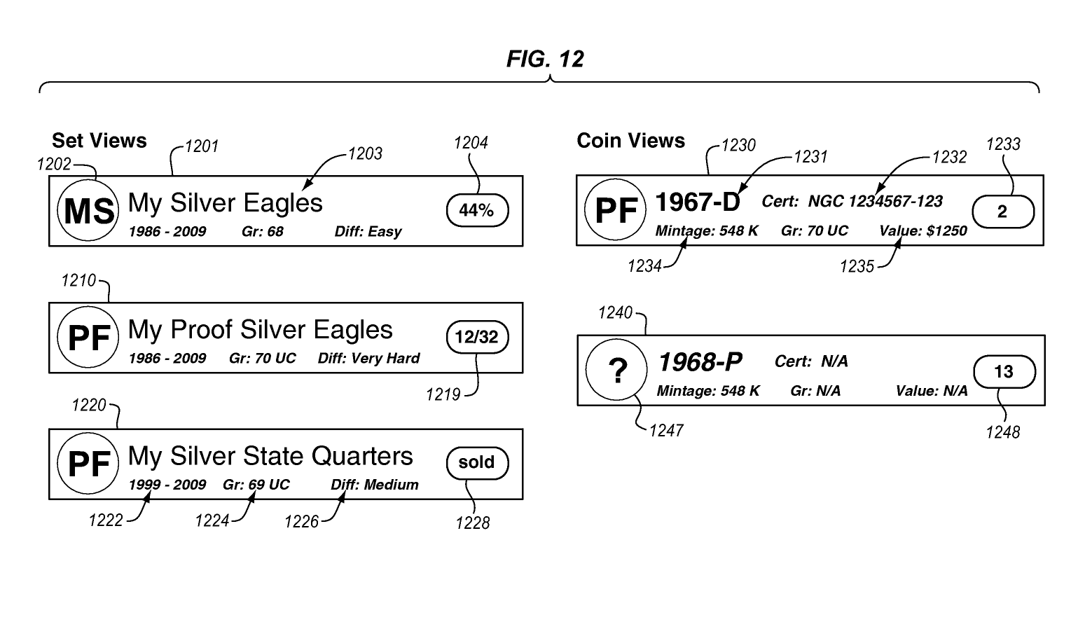

FIGS. 10 through 13 illustrate an exemplary drill down sequence of screens that can be entered from one top level entry item of FIG. 9, namely the “My Coins” item 952. FIG. 10 shows an specific embodiment 1000 of the first level collection screen 400 of FIG. 4 as may be displayed for a particular user's coin collection application if the “My Coins’ toggle 974 of FIG. 9 is clicked on. This screen corresponds to the first drill down lever 203 of FIG. 2. A heading 1004 at the top of the screen identifies the screen as the Root Coins Types screen. A toggle 1002 toggles back to the home screen 900 when activated. The navigation area 1020 of screen 1000 shows a list 1030 of various categories or sets of coins in the particular collection. Each entry in the list 1010 includes a root coin type, such as American Eagle Coins 1015. Adjacent each entry is a toggle 1022 which takes the user to the coins of that type in the collection. For example, if the toggle 1022 next to “Scotts Killer Nickels” is clicked on, the system goes to second level screen 1100 shown in FIG. 11. The meaning of the various symbols in each item in list 1030 is explained in connection with FIG. 12.

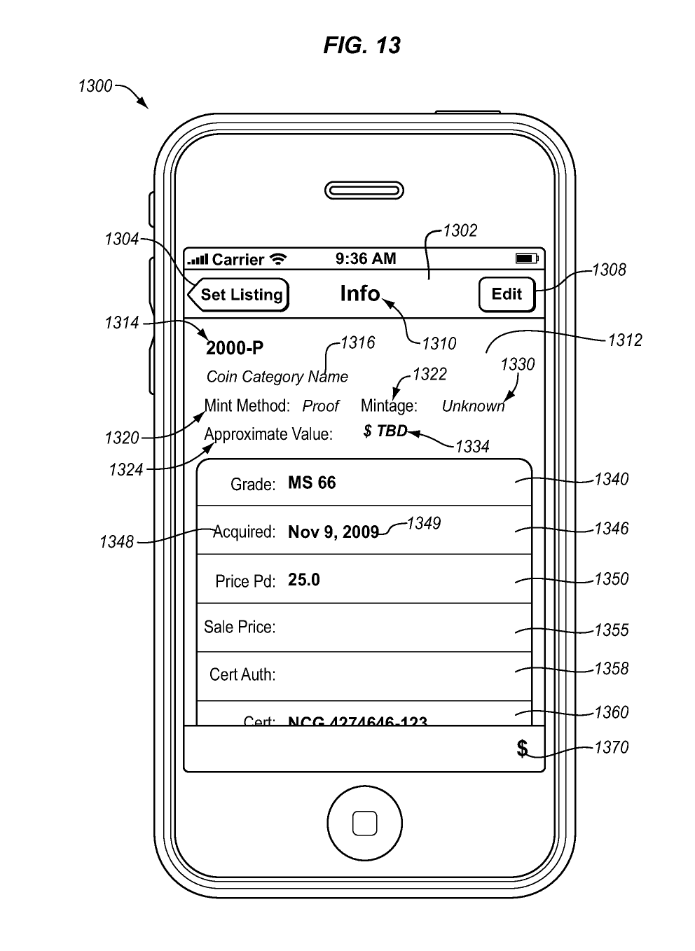

FIG. 11 shows an example of the a second drill down level or collection item type screen 1100 corresponding to the second level 204 of FIG. 2. This example shows what may be displayed when the Scott's Killer Nickels item toggle 1022 of FIG. 10 has been clicked on. Screen 1100 includes a header section 1104 which includes the screen title 1103 and a toggle 1107 to take the user back to second level screen 1000 of FIG. 10. The main navigation area 1120 contains a list 1130 of the nickels in the coin types in the set. The coins in the set are shown in bold, such as at 1122, while coins that exist that could potentially form part of the set are shown grayed out, such as at 1124. Each item also includes a toggle, such as 1128, which takes you to the third level detail screen, such as screen 1300 of FIG. 13. The meaning of the symbols in each item is explained in connection with FIG. 12.

FIG. 12 illustrates typical item entries in the first level screen of FIG. 10, i.e., Set Views, and typical item entries in the second level screen of FIG. 11, i.e., Coin Views. A typical user set entry is shown at 1201. The alphabetical symbol 1202 designates the type of set, in this case “MS” for mint state. Other values used are PF for “proof”, U for “uncirculated”, etc. Numeral 1203 points to a set title determined by user, while 1204 is an indicator specifying completeness, which is a percentage in this case. Completeness identifiers are preferably gray in color. The Date range of coins in the set is shown at 1222, and numeral 1224 points to the target grade for the set, meaning that all coins in the sat will have at least this grade. Relative difficulty to complete the set is indicated at 1226, and 1228 is a Marketplace status identifier, which preferably are colored. In this case, the user is being notified that their set was sold. A second version of an indicator specifying completeness is shown at 1219. In this case it is a fraction. Completeness identifiers are preferably a predetermined color, gray in this case. A typical user coin entry is illustrated at 1230. The date and mintmark of the coin us shown at 1231, and a certification number and the grading company designation are shown at 1232. At 1233, another marketplace status identifier is given, which, as mentioned above, is preferably colored a predetermined color selected for such identifiers. In this case, the user is being notified that there are two offers to buy this coin. How many of this type of coin were minted is shown at 1234, and 1235 shows an approximate current value of the coin. A typical user coin entry for coin missing from a set is shown at 1240, and at 1247 an indicator that the coin is missing is shown. Numeral 1248 designates another marketplace status identifier, which are preferably colored a selected color. In this case the user is being notified that there are 13 of these coins within the system available for purchase.

FIG. 13 shows an example of a detail level collection screen in a coin collection application as may be displayed if the “2000-P” subset of FIG. 11 has been selected by clicking on the toggle 1128. It corresponds to a detail level 206 of FIG. 2. Screen 1300 includes a header section 1302 which includes the screen title 1310, here “Info”, a toggle 1304 to take the user back to second level screen 1100 of FIG. 11, and an “edit” toggle 1105 which permits data to be entered into the screen and edited. The main navigation area 1312 contains detailed information 1330 pertinent to the collectible. Each pertinent detail includes a detail heading, such as 1324, and a data entry area n which the user can enter the information. In this coin application, the pertinent detail includes the Coin Category Name 1316 which is “2000-P” as shown at 1314, the Mint Method 1320, which is “Proof”, the Mintage 1322, which is not known in this case, the Approximate Value, which is designated as TBD, which means “To Be Decided”. The foregoing detail information is preferably always located in the same place in the main navigation area. The main navigation area also includes a scrollable list of detail items 1340, 1346, 1350, 1355, 1358, 1360, and other details. In this iPhone™ embodiment, the list may be scrolled by rubbing a finger up or down on the list, and thus the list details may not always appear at the same place. Each detail item includes a heading, such as 1348, and a piece of detail data, such as 1349. In this particular instance, the detail items that are currently visible on the scroll list include Grade, date acquired, purchase price, sale price, certification authority and the certification number, where the coin was purchased, the purchase price, and the purchase date. Detail screen 1300 may also include a notes data entry area 1348 where the user can enter any additional data pertinent to the coin. A sale process for this coin may be initiated by clicking on toggle 1370.

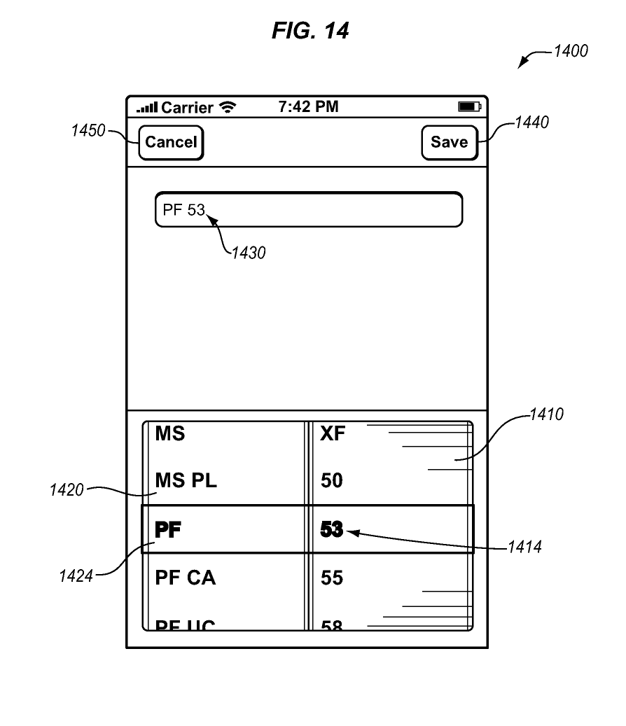

FIGS. 14 through 17 illustrate screens that can be used to manually enter the detail data 1330 in the main navigation area 1312 of screen 1300 of FIG. 13. Screen 1400 of FIG. 14 may be entered by highlighting the grade detail item 1340 of FIG. 13 by touching it and then touching the edit toggle 1308. Screen 1400 includes a data window 1430 and a scroll wheels 1410 and 1420. As this is a touch screen device, the scroll wheel 1420 may be scrolled until the desired grade designation is displayed in window 1424, and scroll wheel 1410 may be scrolled until the desired grade level is displayed in window 1414. In this case the grade designation is PF and the grade level is 53. The designation and level are bolded or brightened when in the corresponding window and the grade designation and level appear in window 1430. If the save toggle 1440 is touched, the entry in the window 1430 is saved in memory and is entered in item 1340 and the system returns to Screen 1300. If the cancel toggle is touched, the system returns to screen 1300 without changing the entry in detail item 1340.

FIG. 15 illustrates an edit screen 1500 that is opened if one of the editable items, such as 1316, 1320, 1330, 1324, 1350 1355 or 1360 is highlighted by touching them and the “edit” button 1308 is touched on screen 1300. The editable item, if there already is an entry, appears in window 1510, or a blank window 1510 is presented if there is no entry. The entry then can be edited by using keyboard 1530. The keyboard can be switched between the numeric keyboard shown and an alphabet keyboard by touching toggle 1425. In this example, a purchase price of $34.12 has been entered in window 1510. The data entered in window 1510 may be saved in memory and entered in the appropriate detail item, such as 1350, on screen 1300 and the screen returned to by touching the “save” toggle 1508, or screen 1300 can be returned to without changing the selected detail item by touching “cancel” toggle 1505.

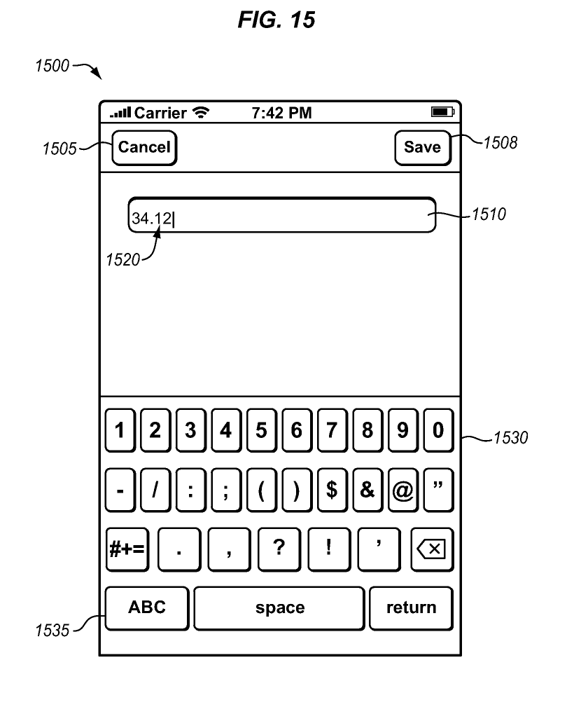

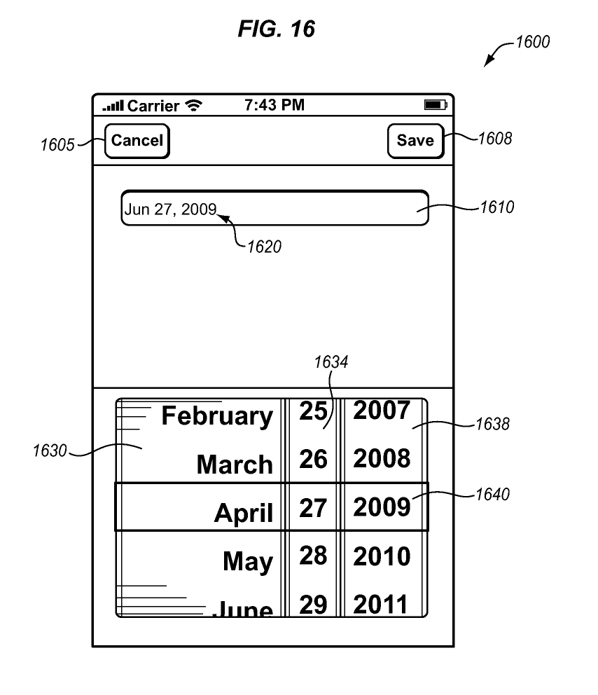

FIG. 16 illustrates an edit screen 1600 that may be entered by highlighting the item 1346 on screen 1300 and touching the edit toggle 1308. This opens screen 1600 which includes a data entry window 1610, three scroll wheels 1630, 1634 and 1638. The scroll wheels may be scrolled to the desired month, day and year by rubbing a finger on them as known in the art. When the month, date or year in window 1640 is touched, the designated month, date, or year appears in window 1610. In this case, the user is in the process of changing the month. When the “save” toggle 1608 is touched, the entry in window 1610 is saved to memory and screen 1300 is returned to with the selected date displayed in detail item 1340. If the “cancel” toggle 1605 is touched the system returns to screen 1300 without saving the date change.

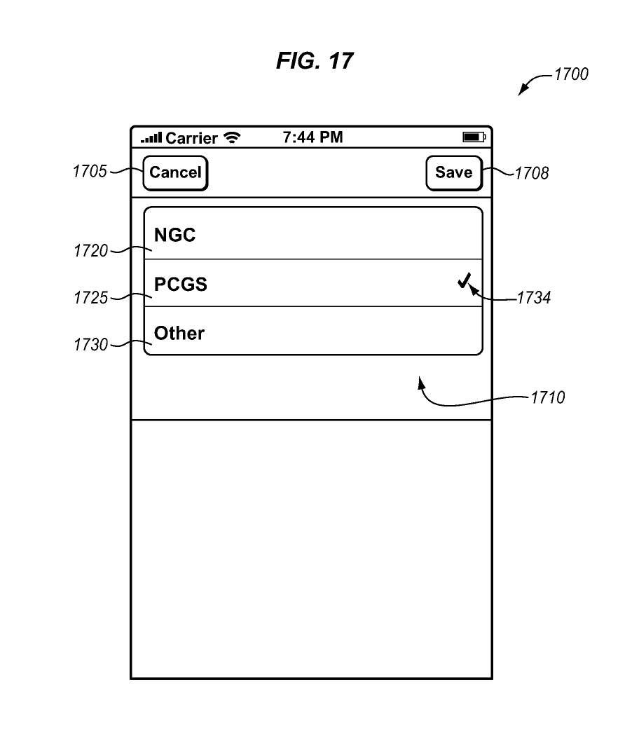

FIG. 17 illustrates an edit screen 1700 that is opened if the certification authority detail item 1358 of screen 1300 is highlighted and the edit toggle 1308 of screen 1300 is touched. Screen 1500 includes a scrollable window 1710 in which the various certification authorities are shown. The appropriate certification authority is selected by touching it, which places a check 1734 on the item selected. The selected authority may be saved to memory and entered in detail item 1358 by touching the “save” toggle 1708. Alternatively, screen 1300 may be returned to without changing the certification authority by touching the “cancel” toggle 1705.

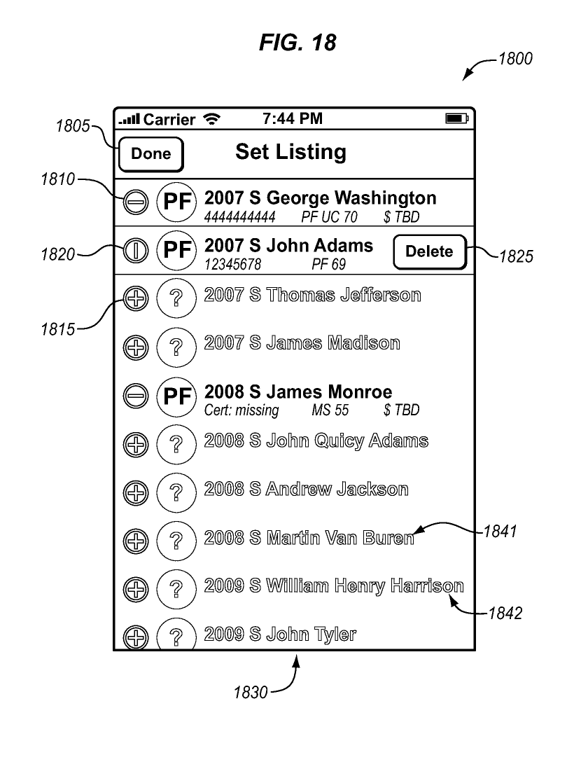

FIG. 18 illustrates an exemplary embodiment of an editing screen 1800 which is entered by clicking on the “Edit” button of a second level or Set Listing screen, such as the screen of FIG. 11. Note that the particular second level screen set from which screen 1800 was reached is not shown in the application but rather screen 18 is a screen that would be reached from the Carl's Proof Prezzies second level set screen that is reached by touching the corresponding toggle on screen 1000 of FIG. 10. This enables us to show a different set, which is a Presidential Dollar Set. Touching the “edit” toggle of a particular Presidential Dollar Set, shows the screen 1800. This set contains at least a 2007 S George Washington, a 2007 S John Adams, and a 2008 S James Monroe, which are shown highlighted, or in bold. The other existing Presidential Dollars in the set are shown grayed out, as, for example, the 2007 S Thomas Jefferson. Screen 1800 contains delete toggles, such as 1810, next to each owned item, which are negative signs in this embodiment. If the delete toggle is touched, it turns vertical, as at 1820, and a “Delete” toggle, such as 1825, appears at the right of the item. Touching the delete toggle, would delete this coin from the set and the entry would turn gray as the other entries of coins that exist but are not owned and the date relating to the deleted coin would disappear. Touching an add toggle, such as 1815 next to a coin entry that is not in the set brings up a screen such as 1300 for that coin that allows the user to enter the data for the newly acquired coin. Touching the done toggle 1805 on screen 1800 returns the screen to a screen such as 1100 of FIG. 11.

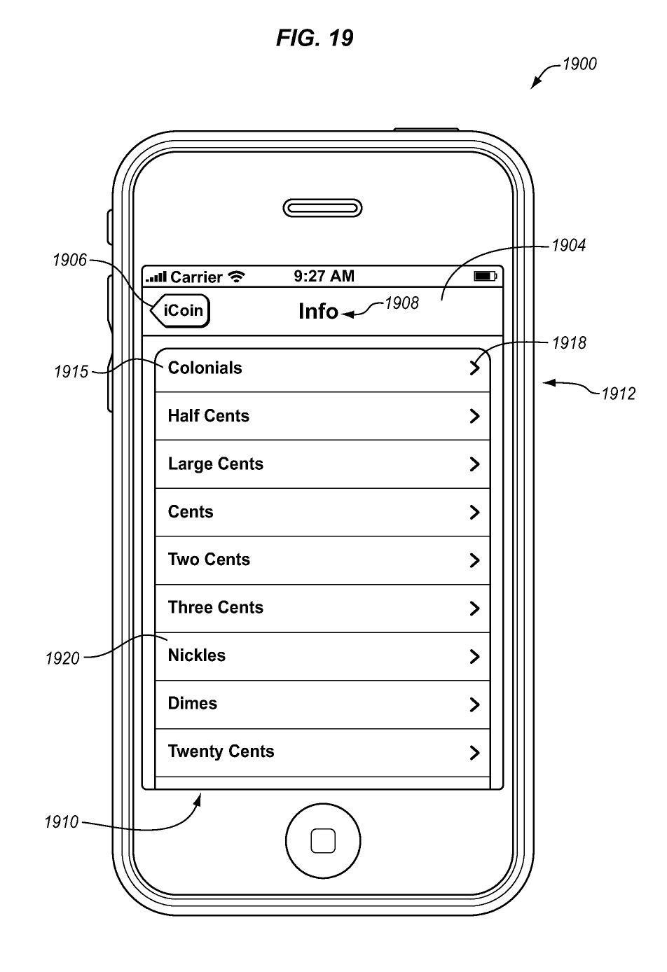

FIG. 19 illustrates and exemplary embodiment of a screen 1900 that is reached via the “Coin Info” item 953 or “Research” item 920 of FIG. 9. When selecting “Coin Info”, or “Research”, the user drills down to a coin through the standard process—root coin type→coin set type→coin detail. This drill down process brings up a screen (not shown) that indicates the various countries which the collector has set up the application to contain. If only one country is selected, the screen goes directly to coins of that country, such as screen 1900 which shows existing United States coins. Thus, screen 1900 presents a navigation area 1912 that contains a scrollable list 1910 of US coins that exist. Screen 1900 also includes a heading area 1904 with the heading 1908, which in this case is “Info”, and a toggle 1906 that takes the system back to screen 1000. The list 1910 is preferably in a logical order, such as ascending order of coin denominations. Each item in the list, such as 1915 has a heading indicating a coin denomination, which in this case is “Colonials”, and a toggle 1918 which, if touched, takes the system to a corresponding list of existing coins of that denomination. For example, if the toggle of the “nickels” item 1920 is touched, an intermediate screen (not shown) appears showing different coin set types within the Nickel category, e.g., Buffalo Nickels 1913-1938, Jefferson Nickels 1938-Date. Once a user selects a nickel set type, then all the coins are shown of that type similar to the list of FIG. 11.

FIG. 11 is similar to a list that is reached on clicking on the add or “plus” button 1010 of a first level screen such as that of FIG. 10. Touching the add toggle 1010 indicates that the user wants to add a coin set. When adding a new set, the same elements within the screen are displayed as shown in FIG. 19 and discussed above, but the user stops at the coin set type level when starting a new set. This will generate a list that of FIG. 11, showing a list 1130 all the possible US nickels that exist, with the item heading grayed out, such as the 2002-P heading in item 1124 and 2003-P heading in item 1125. The screen can then be edited as discussed in relation to FIG. 11 above to list in bold the coins that the user wants to include in the new set. Also, when adding a set there are no back navigation buttons 1906 shown in FIG. 19.

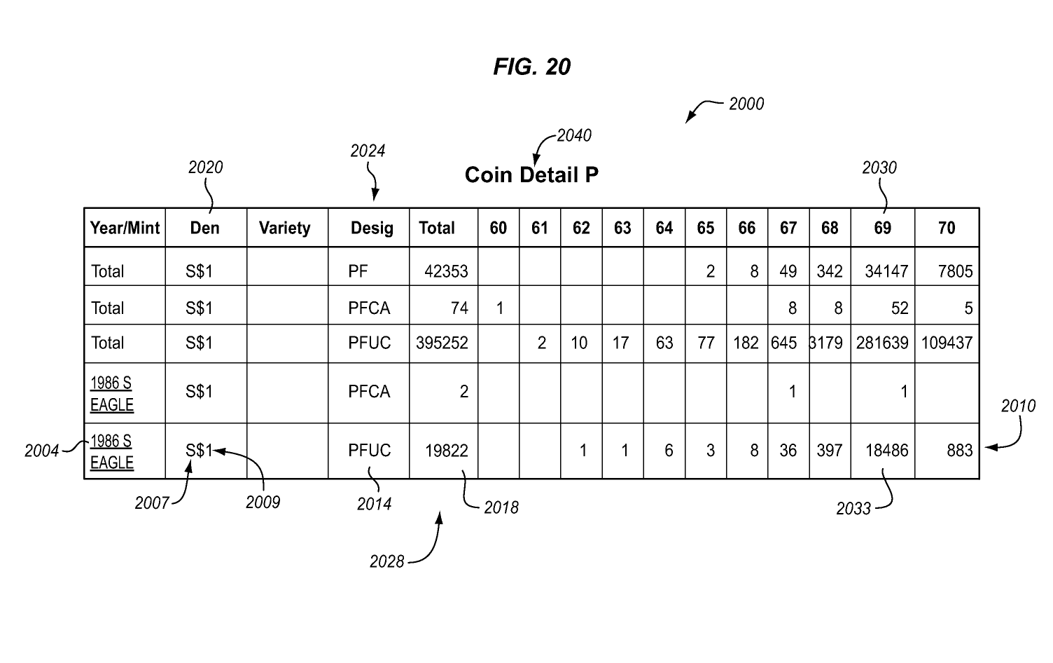

FIG. 20 illustrates population table data 2000 that can be reached via the “Coin Info” drill down item 953 in FIG. 9. Such tables are known in the art, though they are not readily available on a portable application. Population tables derive from the fact that third party grading companies keep track of the number and grade of all coins they grade. The data in the table represents the 1986-S Silver eagle as graded by Numismatic Guaranty Corporation (NGC), though the system of the invention provides similar tables from each grading company. Each row, such as 2010 in the table represents a different grade of the 1986 silver eagle coin. The mint is shown as Denver at 2020. The material is shown as silver at 2007 and the denomination of the coin is shown at 2009. The column 2024 shows the grade designation, such as PFUC (ProoF Ultra Cameo) at 2014, and each of the columns, such as 2030, with a year at the top of the column shows the year of the coin. The total number of coins graded with the particular grade is shown in column 2028. For example, the total number of 1986 silver eagle dollar coins graded as PFUC is shown as 19822 at 2018 and the number of 1969 coins graded as PFCU is shown as 18486 at 2033. That is as per the table, of the 19822 1986-S American Silver Eagle that were graded by NGC as proof ultra cameo (PFUC) there are 883 coins with a 70 grade. A 70 grade represents a perfect coin. This population data is a good barometer of the value of a coin as the rarity of high grade coins often equates to their value. In this table, the grade PF indicates a normal grade and PFCA designates a Proof Cameo grade. The particular grade names are usually created by the grading companies, often as sales tools. Thus, being able to compare grades of different grading companies as is possible with the system according to the invention is of great advantage to a user.

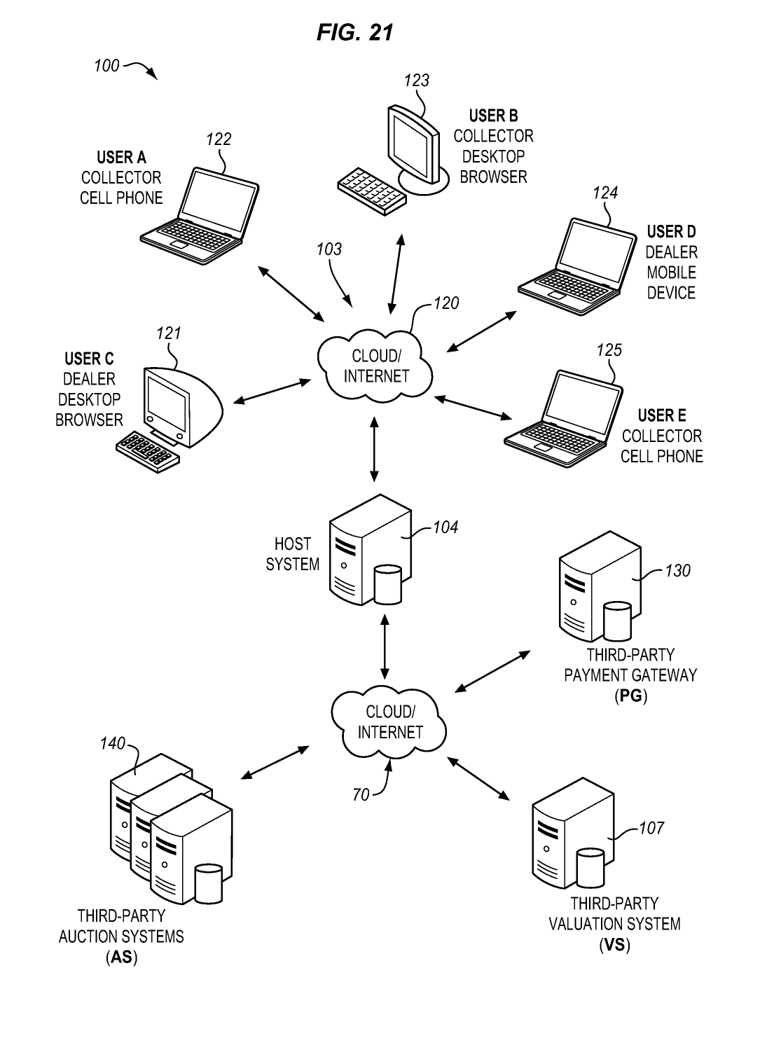

FIG. 21 illustrates the hardware portion of an exemplary system 100 according to the invention such as that of FIG. 1, but from a perspective that illustrates the “coin exchange” feature of the invention. System 100 includes server 104 on which the host application according to the invention is installed. User client computers 121, 122, 123, 124 and 125 have a client application according to the invention installed and communicate with server 104 via the internet 120. The user's computers may include any variety of computer and users such as a dealer using a desktop PC 121, several collectors using cell phones 122 and 125, a collector using a desktop PC 123, a dealer using a mobile device 124, such as a laptop, a cell phone, an iPad™ etc. Each of the client computers 121, 122, 123, 124 and 125 may communicate via host system 104 or directly with each other. Each of the client computers 121, 122, 123, 124 and 125 may also communicate with one or more third party systems 107, 130 and 140 via the internet 70 and host system 104. There are a wide variety of such third party systems, such as third party auction systems (AS) 140, third party Payment Gateways (PG) 130 and third party valuation systems (VS) 107. Many other third party systems such as social networking systems, blogs, information web sites etc. may be communicated to via the host system 104.

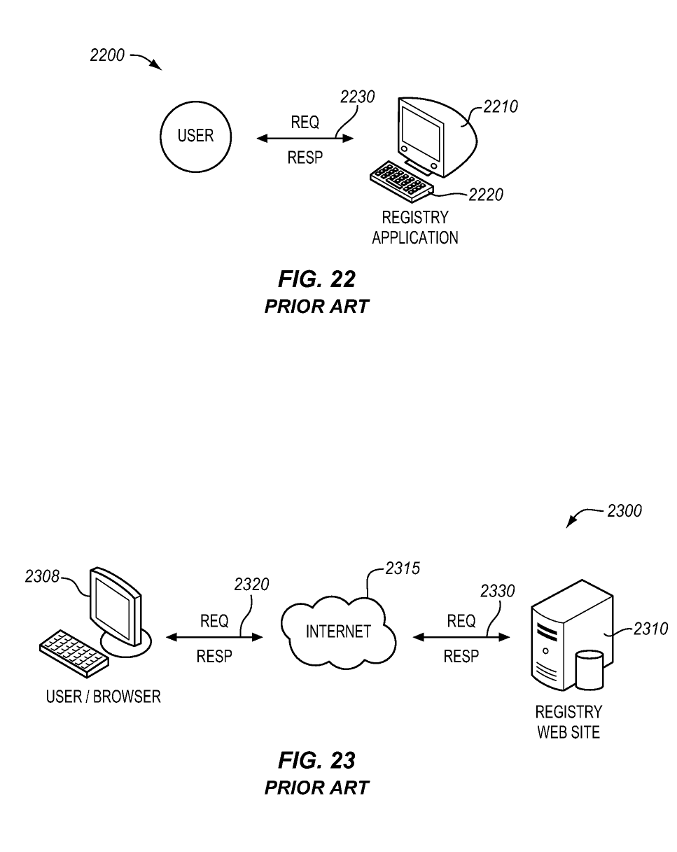

The system 100 according to the invention provides the valuable features of system of the prior art systems in that is allows the user to track their collectibles in an easy centralized manner. The user data exists in the cloud 120, 70 and is available to the user in as many ways as there are software clients that can communicate to the centralized system and consume the data (e.g., iPhone™ app, Andriod™ app, Commercial Internet browser—Chrome™, Safari™, FireFox™, Opera™, etc.). Typical prior art systems are shown in FIGS. 22-25 to assist in understanding how the system according to the invention differs. FIG. 22 illustrates a prior art collection management system 2200 utilizing a client computer 2210 having an input system 2220 and with a registry application installed. A user enters their collectible information into a desktop application registry system. The registry system is typically made up of standard components that comprise a computer application system: namely, a desktop application that produces the user views and a database/data store that is used to persist collection data. The system allows the user to keep track of collectibles they have over time.

FIG. 23 illustrates a prior art collection management system 2300 in which the registry application resides on a server computer 2310. In a typical client/server registry system, a user enters their collectible information into a client system 2308 that communicates the information to a registry web site residing on server computer 2310 via HTTP/HTTPS requests and responses 2320, 2330 that are delivered via the internet 2316. The registry system is typically made up of standard components that comprise a web application system, namely, a web server that produces HTML web pages and a database/data store that is used to persist collection data. Based on a user request (req) the web server in conjunction with the database server produces a response (resp) which is displayed to the client user. The system 2300 allows the user to keep track of collectibles they have over time.

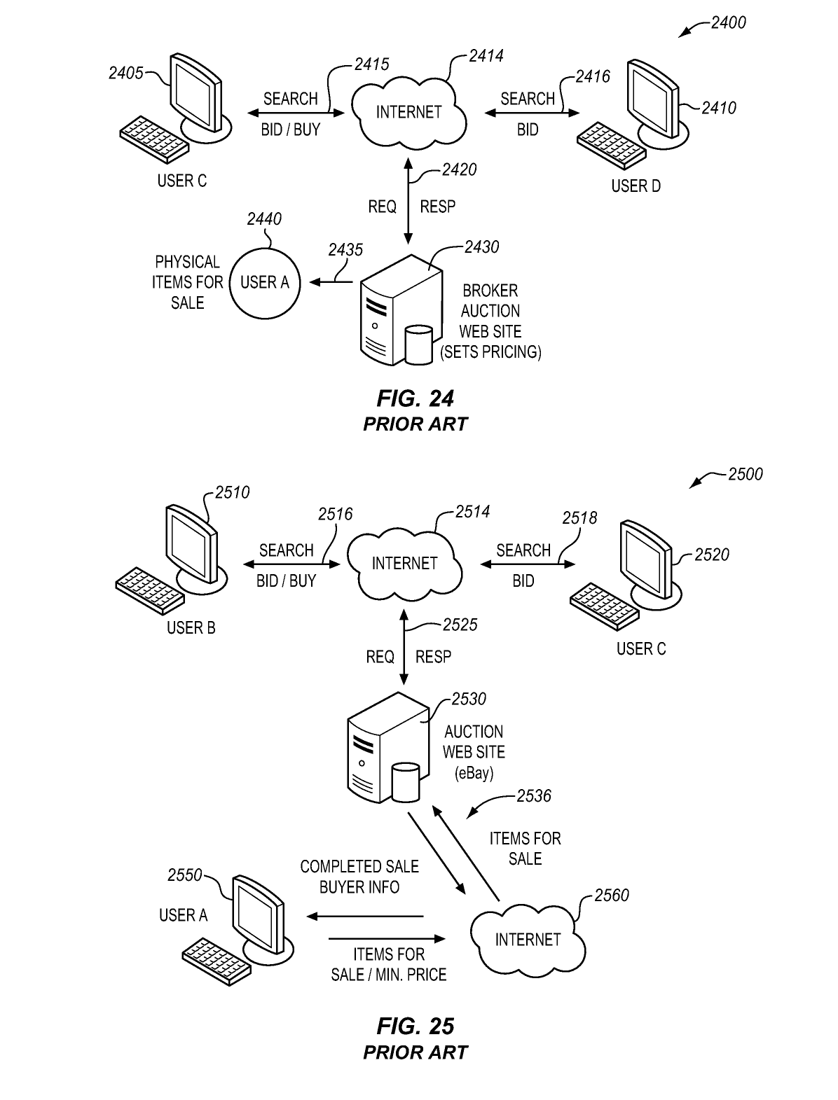

FIG. 24 illustrates a prior art Brokered Auction web site residing on a server computer 2430. Client computers communicate with web server 2430 via the internet 2414 by way of search and bid instructions 2415 and 2416. In system 2400, items are physically delivered to the broker and the broker consummates the sale. User A chooses items from their collection to sell via the broker auction web site 2430 and the broker sets the pricing. User A 2440 physically sends those items to user/broker B. The broker sets the sales price and makes the items available to the general public via web auction. User C and User D bid on the auction item. One user “wins” the auction and is permitted to purchase the item from the broker. The broker collects monies from buyer, broker charges seller a brokerage fee for service, broker sends purchased items to buyer, and broker sends remaining proceeds to seller.

FIG. 25 illustrates a prior art system 2500 in which an auction application resides on an auction server 2530. In a typical client/server auction system, a user enters information about items for sale into a web application based system. The auction system it typically made up of standard components that comprise a web application system; namely, a web server that produces HTML web pages and a database/data store that is used to persist collection data. Users communicate via search and bid/buy requests 2516 and 2518 communicated via internet 2514. Based on a user request (req) the web server in conjunction with the database server produces a response (resp) which is displayed to the client user. Within this system, User A decides to sell an item in their collection. User A transmits sales info including item and min sales price to a third party broker. The broker makes the item visible for sale to the general public in the form of a web-based auction. The broker manages all transactions pertaining to the sale of the item. Users B and C may search the broker's web site for items they wish to purchase. Once an item has been located that Users B and C would like to buy, Users B and C may bid on the auction items. At the end of the auction, one user “wins” and the item is sold to the winning user. The broker, using a third party payment gateway/system, executes financial transaction between buyer and seller. The broker then notifies the seller of the buyer's shipping information. The buyer is notified of the seller's information such that buyer can pay seller via third party payment gateway/system. Broker charges seller a brokerage fee for consummating the sale. Seller upon receiving payment ships item to buyer.

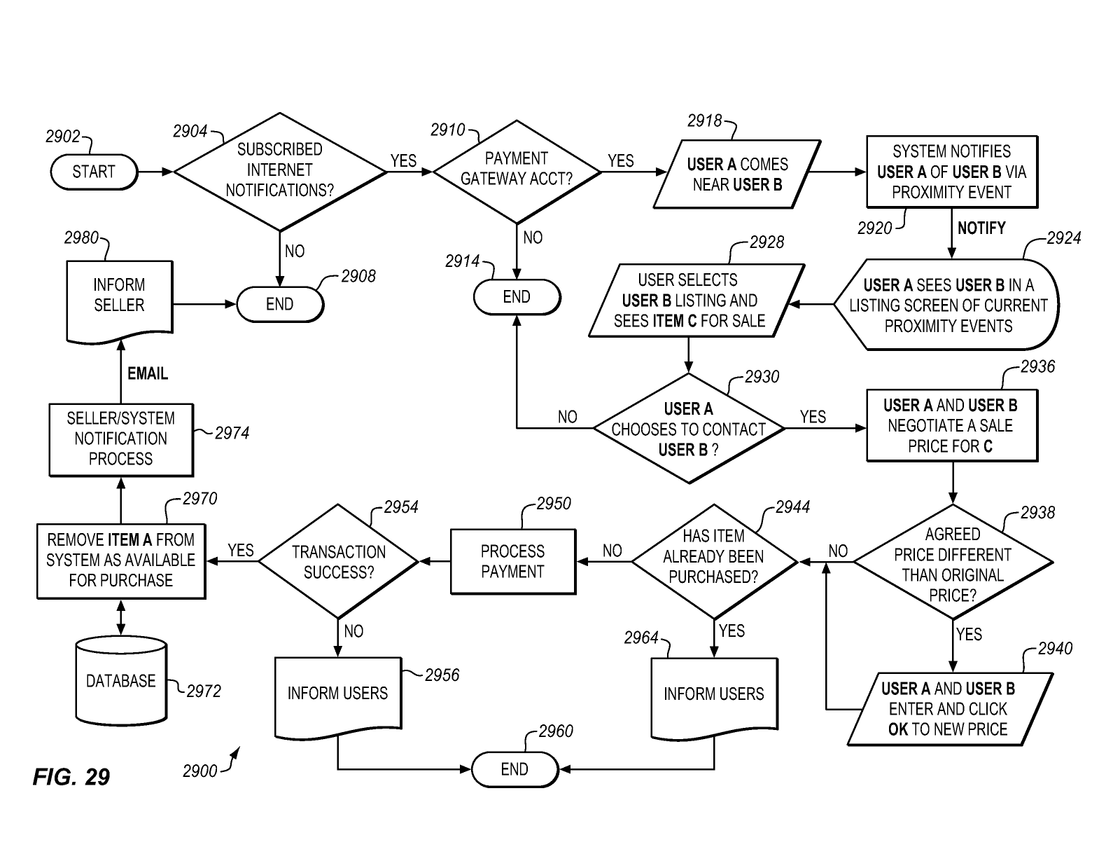

For the average user, there is little difference between system 2200 and system 2300 from a functionality point of view. The real difference between system 2200 and system 2300 is the connectivity requirement and the cloud/centralized nature of the data storage and view generation. The system 100 according to the invention can perform functionally like systems 2200 to interact locally with personal client/storage if the user doesn't have connectivity. Use in this mode precludes internet based sales activities. However, the system of the invention differs in that even in this simplified mode the user may participate in proximity based sales (see FIG. 29), though only cash transactions would be allowed in this case.

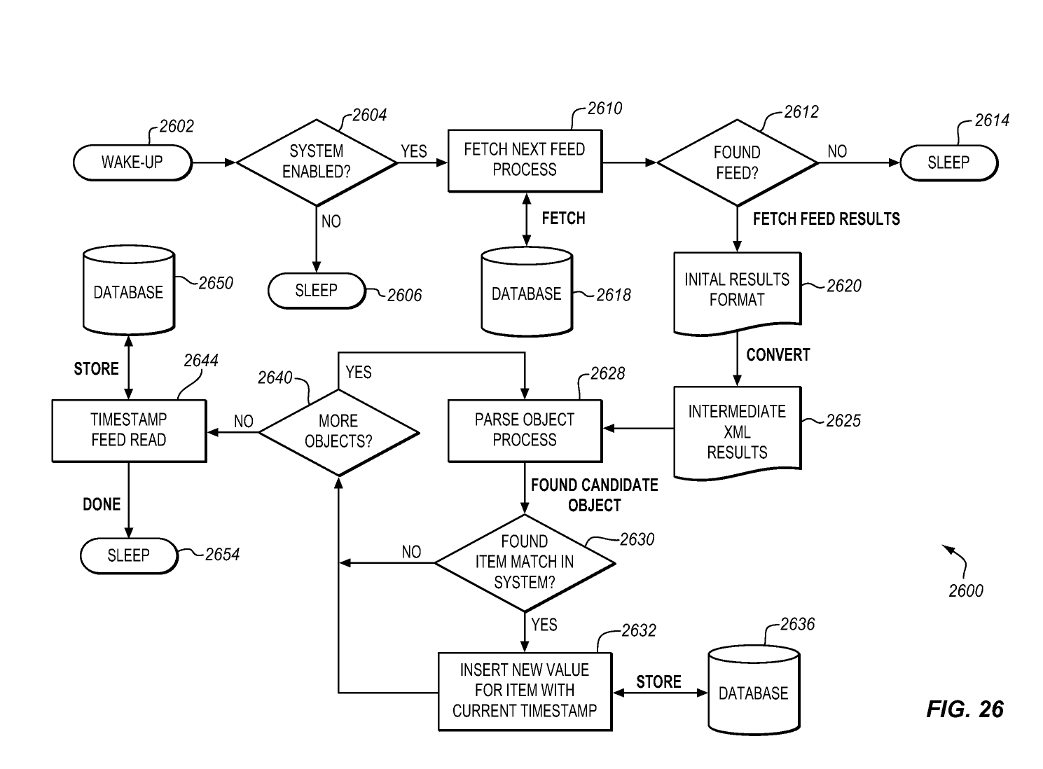

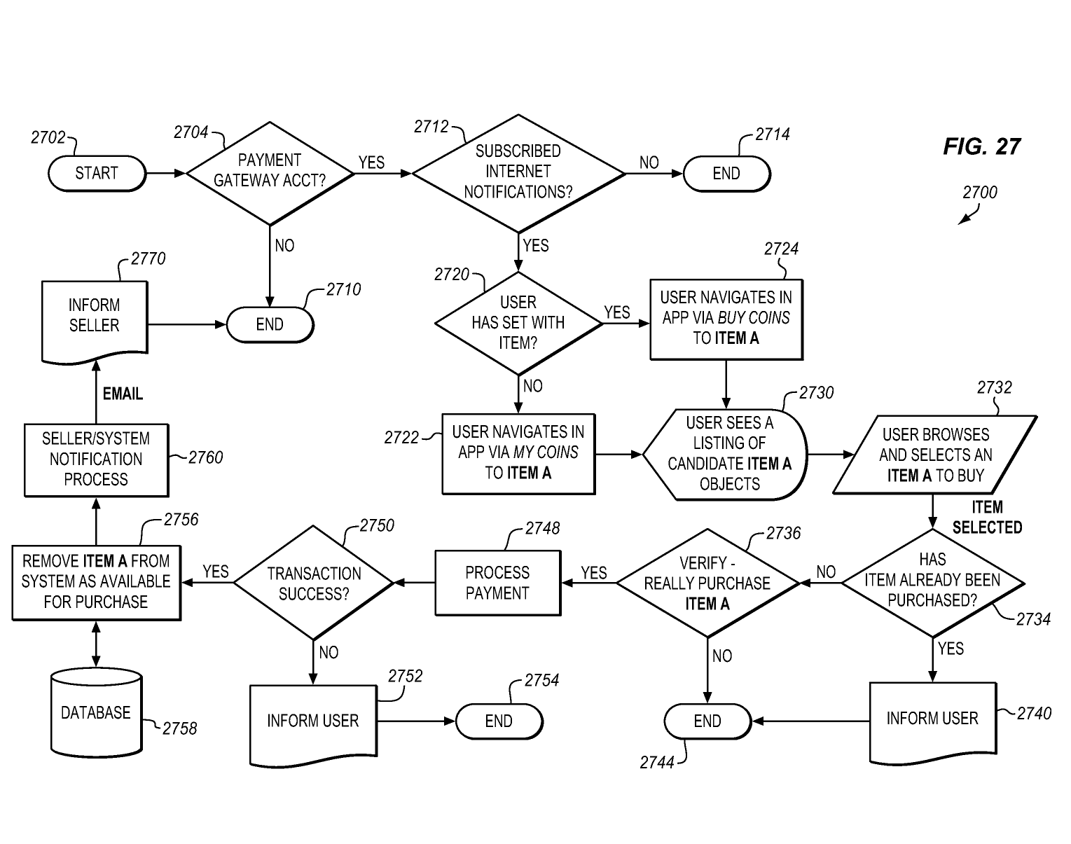

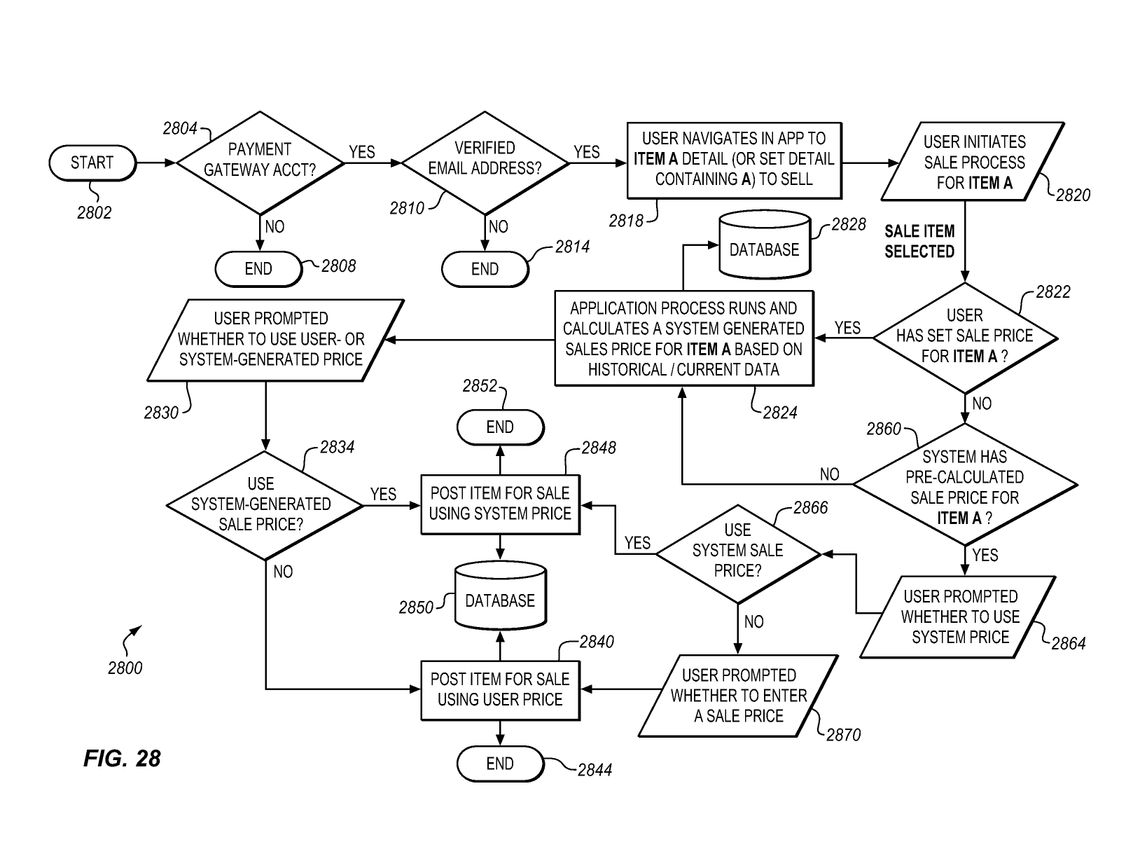

The system 100 according to the invention provides the services of system 2400, but in an enhanced manner. The system 100 gives the seller and buyer tools to determine what an item is worth, which tools are describe below in reference to FIG. 28. The system also allows the seller to completely divorce themselves from the sales process. The user, with the exception of deciding to sell their items, does nothing more than send sold items to the buyer and collects the monies from the transaction. The system provides a more objective view of the value of items a user might sale. There is a much lower probability the seller is taken advantage of by a third party broker that is providing appraisals and setting prices on behalf of the seller. The end user is no longer required to search myriad systems in a possibly volatile environment to try and arrive at a fair value for an item. The system does this for them and provides a simple one click system generated sale price the user may use. Item valuation on the part of the system is based on several factors: existing items for sale prices within the system based on existing item purchase prices provided by users within their collections in the system; historical completed item sales within the system; data mining activities (see FIG. 26); historical/current auction site sales; current dealer listing; reputable third party pricing guides; combination of dealer and market values (see FIG. 26) based on spot pricing at trade shows. The number of remote value feed systems as describe in relation to FIG. 26 will grow over time, and the fidelity of the data for individual items will increase over time as more and more historical data is collected and made available. The system allows buyers and sellers to interact easily via the internet as described in connection with FIGS. 27 and 28. In addition, the system allows for proximity-based interactions as described in connection with FIG. 29. Thus, the system can be considered as an automatic market maker or an exchange, which did not exist at the time of the invention for any known exchanges, even the highly developed exchanges for stocks, commodities, etc. That is, the system according to the invention makes it easy for any collector to also be an anonymous dealer or a well armed purchasing agent without resorting to a middleman.

The system according to the invention provides the services of system 2500, but in an enhanced manner. That is, it provides a medium for buyers and sellers to exchange goods in an efficient and safe manner. The system according to the invention provides a single click means for sellers to sell items directly from their collection. The system automatically makes sale items available to all other users of the system and provides instant targeted buy opportunities to users who are looking at/interested in/collecting similar items they would like to buy. The system can also be configured to post sale items to traditional auction sites on behalf of the user by the system. At the end of the day, the system allows the seller to divorce themselves from the auction sites/sales channels where items might be sold. In essence, the system is acting as a broker/agent on behalf of the seller. There is no need for the seller buyer to deal with a third party auction sites and/or parties. There is no brokerage commission.

By virtue of entering one's collection into a centralized database, the software makes it possible for a user to sell some or all of their items simply by telling the system to make their items available in the exchange. Conversely, that same user can find pieces that they would like in that exchange so that they can add to their collections. All this happens without a third party intermediary acting as an arbiter or market maker for that transaction. It goes somewhat further than conventional auction systems, such as eBay, because it facilitates a collector's ability to buy and sell pieces. Collectors don't have to search the marketplace looking for a target item, the software does this for them. As indicated in FIGS. 11 and 12, the system continually tracks how many offers to sell particular coins exist in the system, and allows the user to buy locate one with a single click or add a particular coin belonging to the collector to those for sale in the system with a single click. It acts as the buyer's agent on behalf of the prospective buyer.

FIG. 26 is a flow chart illustrating a preferred embodiment of a process 2600 according to the invention for ingesting an item value received from a remote system. This system may be disabled on the application host 104 or enabled depending on the operator's desires. Feed sources are stored within a database. An individual feed source may pertain to specific types of items and yield data in a specific format. Within the database, a particular feed may be configured to be consumed at a defined frequency. When fetching results from remote systems, different initial formats will be encountered (e.g. HTML, XML(SOAP), XML, JSON, etc.). Results are converted to an intermediate readily parsable format such as, but not limited to, XML. In some cases, optical character recognition (OCR) may be used. Currently, pattern matching of objects is inexact, it is ultimately limited by the ability to recognize free form text and match it to a known entity, thus, errors will be made during this process. New results are stored in temporary storage. A simple algorithm is applied that looks for values outside of some defined norm before final data is stored in database for use by end users. At the end of the day, this process produces a historical record of value information for items of interest. Process 2600 starts with a wake-up call 2602. At 2604, it is determined if the process 2600 is enabled or disabled on the host system. If it is not enabled, the system returns to sleep at 2606. If it is enabled, the system fetches the next feed process a 2610 from database 2618. If a feed is not found, the system is directed at 2612 to return to sleep at 2614. If a feed is found at 2612, the feed results are fetched in an initial format at 2620. The format is then converted to an intermediate form, preferably XML at 2626. The intermediate format result is then parsed at 2628. A found candidate object is then compared to items in the system for a match at 2630. If there is no found item match in the system, the system determines if there are more objects from the parsing at 2640, and if so, the system loops through 2628 again. If there is a found item match in the system, the match is inserted as a new value for the item with a current time stamp at 2632 and stored in database 2636. When there are no more parsed objects, the time stamp is read at 2644 and the feed stored with time stamp in database 2650 and the system returns to sleep at 2654.

FIG. 27 is a flow chart illustrating a preferred embodiment of a process 2700 according to the invention for purchasing a collectible. This flow chart assumes a user intends to purchase a given Item A. A user must have a payment gateway account (e.g., PayPal) and be subscribed to internet sales notifications within the application in order to participate in item purchase process. Using the application, user navigates to an item listing containing Item A. There may be several items available. User browses and picks a specific Item A to purchase. Items that appear in the list as choices come from other application users selling items from their sets, from items added to the system from posted online auctions (e.g. eBay—“Buy it Now”), or from items posted to the system by item dealers. In the flow chart 2700, the payment process is an atomic process, it either succeeds or fails. In reality, as known in the art, this is a much more complicated process that is not outlined here as the details of this process are known. The process 2700 starts at 2702. The system checks to see if there is a payment gateway account at 2704. If there is not, the process ends at 2710. If there is a payment gateway account, the system checks if the user has subscribed to the internet notification system. If not, the process ends at 2714. If the user has subscribed to the internet notification system, the system checks to see if the user has a set with the item at 2720. If there is such a set, the user navigates in the application via the BUY COINS function 956 to Item A. If there is not such a set, the user navigates to the Item A via the MY COINS function 952 to Item A. In either case, the user is presented a listing of candidate Item A's objects at 2730. Each item in the list is accompanied by as many informational items as discussed above, particularly with respect to FIG. 13, as the seller has entered. The user then browses the list and selects an item at 2732. Upon selection of the item, the system checks to see if the item is still for sale at 2734, and if it is not available, the user is informed at 2740 and the process ends at 2744. If the item has not yet been sold, the system verifies that the user really wants to purchase it at 2736. The payment is then processed at 2748. It is then determined if the transaction has succeeded at 2750. If the transaction has not succeeded because the payment process did not succeed or some other reason, the user is informed at 2752 and the process ends at 2754. If the transaction has succeeded, the item is removed from the system as available for purchase at 2756, which is recorded in the database at 2758. The system then proceeds at 2760 to the seller system notification process, which preferably is by sending seller an email, which informs seller of the transaction at 2779 and the process ends at 2710.

FIG. 28 is a flow chart illustrating a preferred embodiment of a process 2800 according to the invention for pricing and selling a collectible. Flow chart 2800 assumes user intends to sell a given Item A. User must have a payment gateway account and have a verified email address within the application to post sale items. Within the application, user navigates their collection to an Item A detail view, though users may also mark all items within a set for sell. In either case, the user invokes the sell item/items process, such as be touching the toggle 1370. At this point, the system will query the user about pricing, etc., if this information is not already entered in screen 1300. User may subscribe to sales notifications for items within their collection. Upon doing so, user may navigate to item detail views within the application and see past sales for that item for a given period of time. This can be helpful to the user in choosing a sale price for their item prior to selling. The application provides a convenient interface/method to establish item values using historical data. User may choose to enter their own sale price for an item, or user may choose to let the system suggest a price. In either case, the user is queried to verify and approve the final sales price prior to posting the sale item to the system for others to buy. Process 2800 starts at 2802. The system checks to see if the user has a payment gateway account at 2804. If not, the process ends at 2808. If there is a payment gateway account, the system checks at 2810 to see if the user has entered an email address and the address has been verified. If not, the process ends at 2814. If there is a verified email address, at 2818 the user navigates in the application to the item a detail such as in screen 1300 or to a set containing Item A. The user initiates the sale process at 2820 by clicking on the toggle 1370 on screen 1300 or via the items on screen 1000. The process then checks at 2822 to see if the user has set a sale price for Item A. If the user has not set a sale price, the process checks at 2860 to see if there is a pre-calculated sale price for Item A within the system 100. If so, the user is prompted with the system price at 2864 and the user decides whether to use the system sale price at 2866. If the user decides to use the system price, the item is posted for sale using the system price at 2848, this is recorded in the database at 2850, and the process ends at 2852. If the user decides not to use the system price, the user is prompted to enter a sale price at 2870 and when the price is entered, the item is posted for sale using the user price at 2840 and the process ends at 2844. If the process determines at 2822 that the user has set a sale price for the item, such as on screen 1300, the application process calculates at 2824 a system generated sales price for Item A based on historical and current data. The user is then prompted on the system generated price and asked at 2830 whether to use the user set price of the system generated price. If the user decides to use the system generated price at 2834, the item is posted for sale using the system price and this is recorded in the system database at 2850 and the process ends at 2852. If the user decides at 2834 to use the user set price, at 2840 the item is posted for sale at the user price, this is recorded in the database at 2850 and the process ends at 2844.

FIG. 29 is a flow chart illustrating a preferred embodiment of a process 2900 according to the invention for purchasing an item in the proximity of the buyer. The devices used as the proximity devices each have a unique identifier. Users will specify via application preferences a name or handle with which their device will present itself to other devices during a proximity event, for example, “Booth 317”, “User: Bill Smith”, “Dealer: Fine Collectibles, Inc.” etc. Process 2900 assumes User A intends to purchase a given Item C and has subscribed to proximity notifications. It assumes User B is selling a given Item C and posted it for sell within the system. User A must have a payment gateway account, e.g., PayPal, and be subscribed to proximity notifications within the application to participate in this process. A use case for this process might be a collector going to a collector's show, for example a coin show or stamp show, at a local conference center. Another use case might be two users crossing paths at an airport or at a swap meet. The important point is that the system notifies two parties that share a mutual desire to buy/sell a given item when these users come near one another. When User A comes near User B, and User B has an Item C for sell, and User A would like to buy Item C, User A and User B may be notified of each other via a proximity event assuming both User A and User B have enabled proximity notifications. User A may subscribe to receive proximity notifications but not to broadcast notifications. In this use case, User A comes near User B who's selling Item C. User A is notified about User B, but User B is not notified of User A. User A may choose to verbally contact User B by using User B's name/handle, or send a proximity event to User B using the application. In the example of FIG. 29, User A has chosen not to send proximity events to User B. Users A and B may haggle and choose to change the sale price for Item C. In this case, User B must enter the new sale price and both users click okay within the application for the purchase to proceed. In process 2900, the payment process is an automatic process; it either succeeds or fails. In reality, this is a much more complicated process that is not outlined here. Process 2900 starts at 2902. The system checks at 2904 to determine if the user has subscribed to internet notifications. If not, the process ends at 2908. If the user has subscribed to internet notifications, the system checks at 2910 to determine if the user has a payment gateway account. If not, the process ends at 2914. At 2918, User A and User B come near each other. At 2920, the system 100 notifies User A of User B via a proximity event notification. At 2924, User A sees User B in a listing screen of current proximity events. At 2928, User A selects User B from the listing and sees Item C is for sale. At 2930, the system determines whether User A chooses to contact User B, and if not, the process ends at 2914. If User A chooses to contact User B, Users A and B negotiate a sales price for Item C. At 2938, the system determines whether the agreed price is different than the originally listed price on screen such as 1300 of User B for this item. If the price is different, then Users A and B must click okay to the new price at 2940. If the new price is agreed to or if the agreed price is the same as the original price, then the system goes to 2944 where it is determined if the item has already been purchased by another party. If so, Users A and B are informed and the process ends at 2960. If the item has not been sold, the payment is processed at 2950. If the payment transaction does not succeed, the Users A and B are informed at 2956 and the process ends at 2960. If the payment transaction succeeds, process 2900 proceeds to 2970 where Item C is removed from the available for purchase list and the sale is recorded in database 2972. The system also proceeds to 2974 where the Users A and B are sent an email and informed of the sale at 2980. Since Users A and B are in proximity, if User B has the item available, it can be personally exchanged.

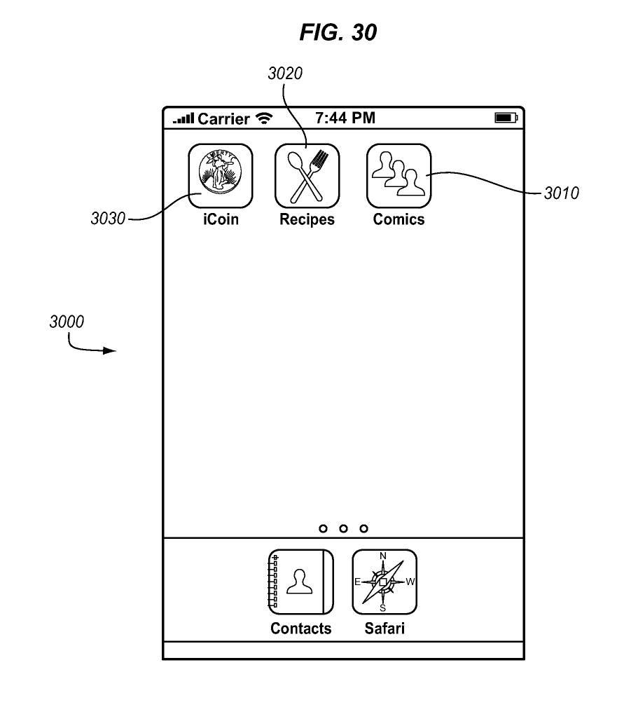

FIG. 30 illustrates an application screen 3000 of a cell phone with several exemplary collection management applications available. An application for coins at 3030, an application for recipes at 3020, and an application for comic books at 3010. Multiple applications on the same computer system may share software. Alternatively, a single application can be designed with subprocesses for a variety of collectibles, which subprocesses can share software.

A feature of the invention is that users may sell their coins from within their coin and set list views on a mobile device. A related feature is that users may subscribe to be notified when other users initiate a sell operation/action of a coin that is missing from their own personal collection. Users may also subscribe for notifications of all such consummated sell events for the coins in their collection, i.e., recent sales. Viewing recent sales provides the collector with up to the moment information on what their coins are worth or are selling for. Users also have the option to automatically set internal coins for sale prices based on recent sales. For instance, a user has a Coin A in their collection. User has requested notifications for coin sales events, user has requested that the “for sale” price of Coin A track with recent sales. Some other application user sells a coin meeting the criteria of Coin A. The user's “for sale” price for their Coin A is changed to reflect the recent sale. If the latest sale is higher than any previous sale and the coin sold and the coin in the user's collection are completely the same, the algorithm in place to determine this price does updates as per latest sale. Otherwise, the update price is an average of recent sales over a predetermined period of time.

When selling a set, all the coins within the set are marked with an internal status of “for sale”. The coins will not actually be made available for sale to other external application users until the seller has verified/established pricing for each coin in the set and acknowledged that the sale should proceed. When selling a coin, if user has not already specified a sell price before hand, or hasn't configured their coin sales prices to be configured by sales notifications, user will be prompted for a sales price for the coin. Upon acknowledging the set sales price, the coin will be made available for sale to other application users.

Before a sale can be consummated, after a buyer has agreed to pay the sellers price, a check is made to determine if another buyer has already purchased the coin. The first buyer to consummate the deal gets the coin. If a user attempts to purchase a coin that has already been purchased, the user will be notified that the coin has already been sold. When the sale is consummated, i.e., when both user and seller agree to the transaction, the coin is removed from the list of coins for sale and from notification services. That is, the coin is no longer available for sale to others. Existing payment services and gateways are utilized, e.g., PayPal, eBay, Apple in App Sales, such that the software can divorce itself from complex payment workflows. A small percentage transaction fee will be assessed for linking buyer to seller, which fee is called a “linkage fee”. Seller pays the “linkage fee”. The software will support only established third party payment gateways and/or clearing houses.

Coin dealers may offer coins for sale to application users for a fee. Dealers normally incur a higher “linkage fee” than a user. Coin Dealers may subscribe for sales notifications. The backend of the application system exposes web services to allow coin dealers to see into sales activity within the application system. Dealers pay a premium for this service. The mobile application will have two runtime modes, one for regular coin collector users and one for dealer users. The application provides additional functionality to dealers. For example, the application provides dealer dashboards, a process via which dealers can view a crosscut of the data and see what's moving, for example, how many silver eagle sales in the last 30 days, what items is selling the most, what's hot, etc. These screens are available when user clicks 960 of FIG. 9.

When a user subscribes to be notified when coins they want become available, the user may drill down through the application to arrive at a list of coins for sale that meet the user's criteria. There may be multiple sellers selling the coin the user wants. Dealers may pay a fee to have their coins show up earlier in the list before others of available coins for sale the user may choose from. The application provides multiple ways for users to find coins dealers, i.e., by zip, by postal code, by location, by text-based search etc. Dealers may pay to have their business appear earlier in the list before others. General advertising is also present in the application, such as dealer banners. In addition, dealers may pay a premium for having a banner show up more often. The application web site provides a full inventory tracking system to small dealers. Certain views within their data/inventory are available to the application mobile client within the Dealer sections.

Coin information publishers may also pay to have their information available to the end user of the application. At the first level of information within the application, the user will have access to publicly available information. Users may also subscribe to more detailed information from other sources.

In addition to regular internet based notifications, the application supports proximity based notifications. Users may enable “convention mode” in which a dealer running the application and a collector running the application will be notified of each other and items they have to sell and want to buy when the collector and dealer are in proximity of each other. For example, say a collector is trying to finish their silver eagle collection. Dealers at the convention will have silver eagles for sale. If the dealer is broadcasting their stock of silver eagles for sale using the application proximity notifications, when a collector walks by the dealer booth, the collector will be notified by the application that a dealer near by has silver eagles the user is interested in buying. Conversely, in the booth, the dealer will be notified of a possible customer. Given the shear amount of notifications the dealer may receive with collectors walking around the floor, preferably the dealer will use a standard computer such as a desktop or laptop computer such that the data can be presented in a more useful manner.

During a “proximity notification” event, buyer and seller exchange unique monikers such that each can identify themselves. This is important as a collector may get proximity events from two dealers near each other and the collector. Users are notified of proximity events in a manner that is consistent with the device they are using, e.g., on a cell phone which may vibrate, on a desktop/laptop the user interface may display a visual alert, etc. A user may select proximity notification methods. That is, a user may select email notifications, SMS notifications, or device notifications such as a custom ring tone or vibration.

The application enables end users, e.g., buyers and sellers perhaps, to communicate without divulging identifying information. This is useful in a case where a buyer and a seller would like to haggle over a price. The application supports viewing of high resolution 2-D and 3-D imagery. This viewer utilizes cartography applications that present finer and finer levels of detail as a user drills down into the view. In the case of a coin application, the view is of a coin. Initially, the user is presented with an image of the coin specimen. Using the standard facilities on the device to zoom into the scene the user may zoom in and look at close up high resolution imagery of the coin. As the user drills down, images tiles are presented for different levels of resolution. As an example, initially the user is presented with a picture of the obverse of a coin, the user then centers the screen on the date of the coin and zooms in. In the next level of resolution, the date portion of the coin may consume nearly the whole screen. The user may center on the second digit of the date and then again zoom in. At this point, the user may only see a couple of digits in the date, etc. The number of resolution levels a user may zoom to is finite.

When the user is looking at general coin detail information for a specific coin, the user is provided with the option to look at coin varieties for the coin, if such varieties exist. For instance, some coins have error varieties. Occasionally, the producer of the raw coins makes a mistake and the coin makes it out to general circulation. These “error” coins, as they are often called, represent a different variety of a given coin. Some coins have many varieties. When the user is in coin detail view mode and selects to view a specific coin variety, the user is automatically presented with imagery of the variety and, if high resolution imagery exists, zoomed down to a high resolution image that outlines the specifics of the variety. Users may view a slide show of the coins in their set. Users may also publish such slide shows via the internet.

According to the invention, the user drills down to a particular coin type in the manner described above in connection with the “My Coins” item 952. At the detail level, population information is displayed about particular coins. In addition, there are views showing graphical representations of grading data. For example, one histogram may be shown highlighting how the counts have changed over a period of time. Views may also show how quickly the number of grading coins are changing over time; that is, the derivative, and dg/dt, where g is the number of grading coins and t is time. Summary views of a group of coins are provided, for instance, as shown in FIG. 20 which shows an optional tabular form showing graded silver American eagles of 1986 date. Other views show comparisons of grading data between grading companies. For instance, PCGS and NGC always have subtle differences in how they grade coins. Being able to plot their data side by side and see trends is invaluable to the individual collector.

The system 100 according to the invention has many other screens. For example, it includes a display style selection screen which is reached by clicking on the Style icon 904 in FIG. 9. On this screen different display styles may be selected, such as normal, black translucent, and black opaque. As another example, the system 100 according to the invention includes an information screen on which various types of information relating to the system may be displayed. This screen is reached by clicking on the about button 903 in FIG. 9 and other figures. This screen shows an application logo, the name of the application, a copyright notice and a done button which takes the system back to the home screen 900 of FIG. 9. This screen will also provide software version information, licensing information as well as give credit for others copyrighted works where required.

The system 100 of the invention may be used as follows. Say, the user is at a swap meet and sees an item they collect. The user would like to know if the item is already a part of their collection. The user would like to know more detailed information about the item. The user would like to know approximately what the item is worth. The user would like to understand how rare the item is. The application provides this information to the user via a platform/device that fits in with day-to-day living on the move, for example, a mobile platform such as a cell phone or PDA.

A key goal of the application is to provide a collector easy access to the state of their collection both in terms of the collection itself, and in terms of the totality of collectibles that exist. The application allows the user to see what they have as well as what they're missing within the context of a given collection. The system according to the invention is composed of multiple host systems, applications and services. In this document, when referring to the application, it is understood that the collection of systems as a whole is implied unless stated otherwise. The application allows the user to display differing visual representation of their existing collection. The application provides the user/collector with easy access to varied data sources for topical research. The application assists the user/collector in location and procurement of missing collectibles within their area of collection, i.e., what collectable dealers near the user offer items the user needs to augment and complete a collection.

FIG. 1 provides a high level system overview. The mobile client device includes the client hardware, client application and client database. The client devices 102 in many of the illustrations herein is preferably an Apple® iPhone™, but could also be the Google® Android® G1, a netbook computer, which is a computer that fits between the cell phone/PDA and the traditional laptop, or any other suitable mobile device, such as a lap top computer. The client application for the Apple® iPhone® is an iPhone client application built using Apple iPhone Development Tools. See the following website for a description of Apple iPhone tools: http://developer.apple.com/iphone. The application also utilizes other tools: See the following web sites for a description of these tools: http://www.sqlite.org/, http://tomcat.apache.org/, http://www.jboss.org/ and http://www.postgresql.org/.

The client database is preferably a file based SQLite database. The web applications and web services deployed are preferably J2EE based. The initial application server is preferably Apache Tomcat, but could be any other system, such as the JBoss Application Server. The preferred application server database is a Postgres database, but could be any other suitable program. Third party server hardware, web applications, application services and databases varies from party to party. Standard interfaces, such as HTTP/HTTPS, JDBC and standard web services are suitable.

The home screen is the first screen to appear after a brief appearance of the copyright screen when the application is launched on the device. For a generalized example of this screen, see FIG. 3 and for a specific application, coin collection, see FIG. 9. At this level of the application, various ways to access the database and other functions are displayed. It should be understood that the user can enter the drill-down-to-detail system 200 of FIG. 2 from a variety of entry points and proceed through it in different directions. From the “My Coins” item 952, the “Coin Info” item 953, or the “Buy Coins” item, for example, the user may go to a screen that permits selection of a collectible item category. For an instance of this screen that is entered from the “My Coins” item, see FIG. 10. At this level of the application, collectible sets 1030 are displayed. The user may select an item from the list to see a list of items that make up that collectable set, such as shown in FIG. 11. A collectible set is simply a collection of items. At this level of the application, a list of collectible objects is displayed. The user may select a collectible object to see details about that object. At this level of the application, details about a particular item are displayed. The first details that are shown depend on the drill down path to the object. The system remembers where the user came from. If the user is coming along the “Coin Info” path, a population table showing the available grading groups for the selected object is shown in the “Coin Detail P” screen 2000 of FIG. 20. If the user is coming along the “Dealer” path via the Dealer entry item 960, dealers who sell the object are shown in a “Coin Detail D” screen (not shown) with the closest dealers listed first. If the user is coming along the Research path through the Research entry 920, the “Coin Detail R” screen (not shown) is the first detail screen shown which lists articles about the coin. The user may choose to look at a picture or image of the item in a “Coin Detail I” screen (not shown). The user may scroll to particular details in any coin detail screen. Clicking on a Notes entry area (not shown) in the scroll list, will enlarge this area and permit the user to enter and read copious notes about the item.

The application does not replace existing coin registries. Partnership with existing registries makes available their user registry data for any user, for a small fee. The application is designed to sync data with available third party registries. The application permits the user to configure registries to sync via application preferences. The application provides the user with the ability to manually initiate a synchronization process and provides the user with the option of scheduling a synchronization process with a given registry. Synchronization from the client device to the application host is preferably a manual process in that the user must be running the application on the device for the synchronization to occur. Presently, in the preferred embodiment, the synch from device to application server cannot occur on the device in the background because of a current limitation of the iPhone: only one process may be running at a time. However, such synchronization is already designed for when it becomes available on mobile platforms.

User data will reside and be stored on the mobile client device 102 and on the application server database 104. User data may also be resident on third party systems. User data stored on third party systems may be managed by the application server via user request or automated scheduled synchronization processes. User data stored on the client device is managed by the application server via user request or automated scheduled synchronization processes. Data changes made on the client preferably are written to the local database as well as archived to a local file. The local file preferably lists the actual SQL statements executed against the local database. Entries in the local file are preferably written in chronological order, with the written time stamps converted to Greenwich Mean Time (GMT). An overview of the process flow for client side data updates is shown in FIG. 6. Server side data changes are managed in much the same fashion as client side data changes. The changes preferably are written to the database and also archived. In the server side case, the archival is in the database vs. local file. When the client application first launches, it preferably automatically attempts to upload any archived client side changes to the server. This upload process may also be initiated manually by the user using the application. For an overview of the process flow for client side data uploads, see FIG. 6. After the upload of archived database changes, the client will then request the pending server database changes that need to be applied locally. As part of the server side data reconciliation process pending server data changes are written to the database for later retrieval by the client. The server preferably accepts uploads from the client that contains client side database changes. The server reconciles the client side and server side database changes. The server side database is updated as part of this process. The server also generates a list of changes that the client needs to apply. For an overview of the process flow for client side data uploads, see FIG. 8. Reconciliation of data changes from the application to and from third party systems is preferably handled on a case by case basis. Third parties provide web services that can be queried on a per user basis to get data updates made on those systems. Data preferably arrives from third party sources via web service or screen scraping on the server side.

From the collector's perspective, the grading process is quite simple. A collector submits coins to a grading company, the grading company evaluates the coin, gives it a grade, and sends it back to the collector. As part of the grading process, the coin is “slabbed”. Slabbing is a technique where the coin is mounted inside an airtight plastic container about the size of a credit card. The grading information is prominently displayed within the slab. The grading company keeps track of each of the coins they grade. As a paid service, the grading company publishes population data for all the coins they have graded. For instance, using this population data it is possible to determine how many 1996-P American Silver Eagles with a grade of PF-70 have been certified by NGC. Coins received by a grading company within 30 days of being released from the mint are eligible for a special grading designation, such as Early Release, First Strike, etc. The value of a particular coin is influenced by many factors. The number of coins produced by the US Mint can influence the value of a particular coin. Sometimes a certain coin becomes very popular among collectors and increases in value as a result on an increase in demand. Some coins are produced using precious materials like silver and gold. These coins change in value as the value of precious metals change. The value of a coin is also greatly affected by its grade. Higher grade coins carry higher prices. In addition to this, if a coin has a high grade and a low graded population within that grade, the coin may be worth much more. Coin grade and population are important aspects in making judgments as to the value of a coin and are available to the user on the application according to the invention. The present application allows the user to track their collection on other levels. For instance, the application provides information on how much was paid for a given item, where, when and from whom was the item purchased, what is approximate the current value of a given item, and what value has a given item sold for recently in auctions.

The application also helps the user research numismatics from a high level. The application consolidates general information in the realm of numismatics and presents it to the user in a simple clean navigable fashion. The application allows the user to examine high resolution imagery of different coin types. This imagery preferably is hosted from the centralized server location 104. The application also provides location based targeted advertising to users. Numismatics vendors have the ability to buy advertising and provide content that is targeted toward users within the application display based on where they are. For instance, if the user is in Florida, and brings up the map portion of the application, the user will see the numismatic dealers that are within a user-configurable distance of their current location. The application also provides location based calendaring. If the user happens to be traveling in a given location, the application displays information regarding local numismatic events within a user-configurable distance of that location. The application preferably displays near real time data for the price of precious materials like silver, gold and platinum. The application subtly displays advertising information to the user. The application provides a service for dealers/advertisers to register/pay for their ads to be displayed. The application preferably uses user location information as an input to determine which ads to display. For example, if the user is in a specific area within the US, ads from that locale has a slight advantage in being displayed vs. ads with a higher general priority, i.e., ads for which a dealer paid more for the ad. The application also provides near real time views of the state of the market from a numismatic perspective, such as providing near real time population data and population alerts. The application preferably displays location based information on a map. The user can enter requests such as “Show me all the coin dealers within 20 miles of where I am now”, or “Show me on the map indicating the locations of all the coin shows in Colorado, and the corresponding map will be displayed.

The application preferably also makes US Mint Historical Data, such as Red and Blue Book data available to the average collector. The inventor is planning to enter arrangements with registry sites that in exchange for using the registry information, the application will drive business to registry. However, preferably, the data in the system database is gathered by using a community of users to populate the application data. The users are requested to provide permission to use any data they enter into their system. As incentives to have users populate the database, the invention allows the user to access the data pertaining to the user's collection from anywhere a telephone wireless signal or an internet connection is available, the invention helps the user identify “errors” within a given area, for example, missing edge lettering, double die errors, etc., and the invention also helps users find local dealers, and, in particular, and find local dealers selling coins in the user's sets. As other incentives, the system of the invention provides a calendar of pertinent conferences/events in the collectible area and the users location and provides location based real time alerts of events conferences in the collectable area at a given user locale.

There has been described a system for managing data associated with collections, such as coin or stamp collections. The invention can be used in a wide variety of applications including car collections, trading card collections, and many other collectibles. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiment described, without departing from the inventive concepts. Equivalent structures and processes may be substituted for the various structures and processes described; the subprocesses of the inventive method may, in some instances, be performed in a different order; or a variety of different materials and elements may be used. Consequently, the invention is to be construed as embracing each and every novel feature and novel combination of features present in and/or possessed by the collection data management apparatus and methods described.

I claim:

1. A method for assisting a collector of collectible items, said method comprising:
establishing a collection database on a server computer system, said collection database including: a first list of collectible items of a type selected from the group consisting of coins, stamps, comic books, books, artworks, trading cards, motor vehicles, recordings and autographed documents, said first list associated with a collection identifier; first detail information relating to said collectible items in said first list; a second list of collectible items of the same type as the type of items in said first list, said second list including items in a particular category of said type of collectible and having at least one collectible item not on said first list; and second detail information relating to said collectible items in said second list;
providing a client computer system remote from said server computer system, said client computer system including an input device, a memory, a processor and a display;
establishing a collection management tool on said client computer system, said collection management tool including said first list of collectible items and said collection identifier;
establishing a communications link between said client computer system and said server computer system;
entering on said client computer update information regarding said first list of collectible items associated with said list identifier;
updating either said first list of collectible items associated with said collection identifier or said detail information relating to said collectible items in said first list on said server computer based on said update information;
displaying on said display of said client computer a listing of categories of said collectibles;
responsive to input from said input device, requesting a list of collectible items in a the category corresponding to the category of said second list;
displaying said second list of collectible items on said display; and
responsive to input from said input device, retrieving and displaying second detail information relating to a collectible item in said second list not on said first list.

2. A method as in claim 1 wherein:
said first detail information comprises two pieces of detail information selected from the group consisting of: the date of purchase of a selected collectible item on said first list, the place from which said selected collectible item was purchased, and the purchase price of said selected collectible item; and
said second detail information comprises two pieces of detail information selected from the group consisting of: the date of manufacture or issue of a class of collectible items of one of said collectible types; a quality grade of one or more collectible items in said class; rarity information regarding the number of collectible items having said quality grade in said class; and the identification of where collectible items in said class may be purchased; and a published article about a collectible item.

3. A method as in claim 1 and further comprising: displaying on said first client computer display a picture of a selected item on said first list and displaying on said first client computer a current monetary value of a selected item in said first list.

4. A method as in claim 1 wherein said collectible item comprises coins and further comprising displaying on said client computer display the spot price of one or more precious metals.

5. A method as in claim 1 and further comprising connecting said client computer to a registry for a collectible item on said first or second list.

6. A method as in claim 1 and further comprising finding a dealer in one of said types of collectible items within a predetermined distance from said client computer.

7. A method as in claim 1 and further comprising selecting one of said displayed categories of collectibles, and creating a third list of collectibles in said category by automatically populating said third list with items in said selected category that exist.

8. A system for assisting a collector or collectible items, said system comprising:
a server computer system;
a collection database on said server computer system for storing information regarding collectible items selected from the collectible types consisting of coins, stamps, comic books, books, artworks, trading cards, motor vehicles, recordings and autographed documents; said collection database including: a first list of collectible items of a first type, and first detail information relating to said collectible items in said first list;
a first client computer system remote from said server computer system, said client computer system including a first input device, a first memory, a first processor and a first display;
a communication network connecting said server computer and said client computer; and
a drill-down tool on said client computer for accessing said detail information, said drill-down tool having a plurality of levels including: a collectible category level in which a plurality of categories of said first collectible type are listed on said display, a collectible item level in which individual collectible items of said collectible type are listed on said display, and a collectible detail level in which detail information relating to a selected one of said individual collectible items are displayed on said display.

9. A system as in claim 8 wherein said detail information comprises two pieces of information selected from the group consisting of: a picture of one of said individual collectible items; the date of manufacture or issue of a class of collectible items of one of said collectible types; a quality grade of one or more collectible items in said class; a current monetary value of said individual collectible item; rarity information regarding the number of collectible items having said quality grade in said class; a published article relating to said selected individual collectible item; a list of dealers which sell collectible items in the same class as said selected individual collectible item; and a population report relating to collectible items in the same class as said selected individual collectible items.

10. A system as in claim 9 wherein said detail information comprises the identification of a collection of which said individual collectible item is a part.

11. A system as in claim 7 wherein said collection database on said server computer system further includes a second list of said collectible items of said first type, and second detail information relating to said collectible items in said second list, said system further comprising:
a second client computer system remote from said server computer system and said first client computer system, said second client computer system including a second input device, a second memory, a second processor and a second display, said second computer system connected with said network; and
a drill-down tool on said second client computer system for accessing said second detail information, said drill-down tool having a plurality of levels including: a collectible category level in which a plurality of categories of one of said collectible types are listed on said display, a collectible item level in which individual collectible items of said collectible type are listed on said display, and a collectible detail level in which second detail information relating to a selected one of said individual collectible items in said second list are displayed on said second display.

12. A system as in claim 8 wherein said collectible item comprises coins.

13. A method of buying, selling or exchanging collectibles, said method comprising:
establishing a collection database on a server computer system, said collection database including: a first list of collectible items of a first type selected from the group consisting of coins, stamps, comic books, books, artworks, trading cards, motor vehicles, recordings and autographed documents, said first list associated with a first collection identifier; first detail information relating to said collectible items in said first list; a second list of collectible items of said first type, said second list associated with a second collection identifier; and second detail information relating to said collectible items in said second list;
providing a first client computer system and a second client computer system, each of said first and second client computer systems being remote from said server computer system and each said client computer system including an input device, a memory, a processor and a display;
establishing a collection management tool on said first client computer system, said collection management tool including said first list of collectible items and said first collection identifier;
establishing a collection management tool on said second client computer system, said collection management tool including said second list of collectible items and said second collection identifier;
establishing a communications link between said client computer systems and said server computer system;
indicating on said first client computer system that a first item on said first list is for sale and communicating said first item and said indication to said second client computer;
using said collection management tool on said second client computer, retrieving said detail information relating to said first item; and
using said collection management tools on said first client computer and second client computer, selling said first item to a user of said second computer.

14. A method as in claim 13 wherein said communicating said first item to said second computer comprises:
providing on said second computer a list of items in a first category, wherein said first category is a category that includes said first item; and
providing on said list near said first item a visual indication that said first item is available for sale.

15. A method as in claim 14 wherein said visual indication comprises the number of said first items in said collection database that are for sale.

16. A method as in claim 13 wherein at least one of said first and second computers is a portable computer and further comprising providing a notification on said first computer, said second computer or both that said first computer is near said second computer.

17. A method as in claim 13 and further comprising automatically determining a price for said first item using price information in said collection database, said price information selected from the group consisting of: prices for existing items for sale within said database system; historical completed item sales within said database system; historical or current auction site sales; current dealer listings; third party pricing guides; and spot pricing at a trade show.

18. A method as in claim 13 wherein said collectible item type comprises coins.

19. A method of buying, selling or exchanging coins, said method comprising:
establishing a collection database on a server computer system, said collection database including: a first list of coins, said first list associated with a first collection identifier; first detail information relating to said coins in said first list; a second list of coins, said second list associated with a second collection identifier; and second detail information relating to said coins in said second list;
providing a first portable client computer system and a second portable client computer system, each of said first and second portable client computer systems being remote from said server computer system and each said client computer system including an input device, a memory, a processor and a display;
establishing a collection management tool on said first client computer system, said collection management tool including said first list of coins and said first collection identifier;
establishing a collection management tool on said second client computer system, said collection management tool including said second list of coins and said second collection identifier;
establishing a communications link between said portable client computer systems and said server computer system;
providing on said first portable client computer an indication that a particular coin in a particular category of coins on said first list is for sale;
providing on said second portable client computer system that a user of said second portable computer desires to buy a coin in the category of said particular coin; and
providing on either said first portable computer that or said second portable computer that said first and second portable computers are in proximity to each other.

20. A method as in claim 19 and further comprising providing to said first portable computer, said second portable computer, or both pricing information selected from the group consisting of prices for existing coins for sale within said database system; historical completed coins sales within said database system; historical or current auction site coin sales; current coin dealer listings; third party coin pricing guides; and spot pricing at a coin trade show.
